(19) United States
(12) Patent Application Publication
(10) Pub. No.: US 2019/0118252 A1
(43) Pub. Date: Apr. 25, 2019

(54) INDUCTION HEATING SYSTEMS AND TECHNIQUES FOR FUSED FILAMENT METAL FABRICATION

(71) Applicant: Desktop Metal, Inc., Burlington, MA (US)

(72) Inventors: Uwe Bauer, Cambridge, MA (US); Nicholas Graham Bandiera, Burlington, MA (US); Emanuel Michael Sachs, Newton, MA (US)

(21) Appl. No.: 16/165,843

(22) Filed: Oct. 19, 2018

Related U.S. Application Data
(60) Provisional application No. 62/575,092, filed on Oct. 20, 2017.
(60) Provisional application No. 62/575,133, filed on Oct. 20, 2017.

(51) Int. Cl. B22D 23/00; H05B 6/14; B33Y 10/00; B33Y 30/00

(52) U.S. Cl. CPC B22D 23/00; B33Y 30/00; B33Y 10/00; H05B 6/14

(57) ABSTRACT

A nozzle for extruding metal containing multi phase (MCMP) build material is heated by an induction coil. The nozzle effective radius is larger than an induction skin depth in the nozzle, which is larger than 1/15 the radius, and less than the nozzle length. The nozzle material performance index, based on resistivity and magnetic permeability, is higher than that of the build material, and components of a build platform, particularly a removable sheet. The coil radius is less than 1.4 times the nozzle effective radius. The nozzle may be of several annular sections, of which that of the bore may be removable and wear resistant. The nozzle may be of multiple graphite grades, including copper infused. The coil axial extent may be less than the nozzle length, and it may be located nearer to the outlet. An adhesion control layer on a build sheet may enhance or reduce adhesion thereto.

### CROSS-REFERENCE TO RELATED APPLICATIONS

This application claims priority to U.S. Provisional App. No. 62/575,092 filed on Oct. 20, 2017, entitled Extrusion Nozzle For Semi-Solid Metal Additive Manufacturing, the full disclosure of which is hereby incorporated herein by reference in its entirety. This application also claims priority to U.S. Provisional App. No. 62/575,133, filed on Oct. 20, 2017, entitled Semi-Solid Metal Additive Manufacturing, the full disclosure of which is also hereby incorporated herein by reference in its entirety.

This application is also related to the following U.S. patent applications: U.S. Prov. App. No. 62/268,458, filed on Dec. 16, 2015; U.S. application Ser. No. 15/382,535, filed on Dec. 16, 2016; International App. No. PCT/US17/20817 filed on Mar. 3, 2017; U.S. application Ser. No. 15/450,562, filed on Mar. 6, 2017, U.S. Prov. App. No. 62/303,310, filed on Mar. 3, 2016; U.S. application Ser. No. 15/059,256 filed, on Mar. 2, 2016; U.S. application Ser. No. 16/035,296, filed on Jul. 13, 2018, entitled THERMALLY ROBUST NOZZLE FOR 3-DIMENSIONAL PRINTING AND METHODS OF USING SAME; U.S. application Ser. No. 16/038,057, filed on Jul. 17, 2018, entitled ADDITIVE FABRICATION USING VARIABLE BUILD MATERIAL FEED RATES; and U.S. application Ser. No. 16/125,181, filed on Sep. 7, 2018, entitled NOZZLE SERVICING TECHNIQUES FOR ADDITIVE FABRICATION SYSTEMS. Each the foregoing applications is hereby incorporated herein by reference in its entirety.

### FIELD

The present disclosure generally relates to additive manufacturing of metal objects using an inductively heated nozzle.

### BACKGROUND

Fused Filament Fabrication (FFF) of metallic materials requires temperatures that are much higher than those required for polymers. Variations in the thermal load are prevalent and there is thus a need for fast and efficient delivery of large amounts of thermal power into the extrusion nozzle. This is further exacerbated by the high thermal conductivities of metal build materials. Thus, there is a need for a method of heating other than resistive heating for FFF of metal build materials. There is also a need for stable temperature in the nozzle, which is difficult to provide with resistive heating. Thus, objects of the present teachings hereof are to provide a means of heating metallic materials in a FFF system that do not rely on resistive methods. Further, there is a need to provide such heating in an energy efficient manner.

### SUMMARY

A method of the present teachings hereof is a method of heating a fused filament fabrication extrusion nozzle that is constructed from a nozzle material, and has a length L and an effective radius r, the method comprising, operating an induction coil at an induction frequency f chosen such that the nozzle has an induction skin depth s at the induction frequency f such that: the nozzle induction skin depth s is less than the effective radius r; and the nozzle induction skin depth s is larger than 1/15 of the effective radius r. The nozzle induction skin depth may also be less than the nozzle length L. The nozzle may conveniently comprise: an annular outer body having an outer body outer effective radius equal to the effective radius r; and an inner tube. The method further comprises providing a metal containing multi-phase build material into the nozzle. The nozzle typically comprises a nozzle material that has a higher performance index (discussed below) than that of the build material. The induction coil may substantially surround the nozzle, and the coil may have an axial extent that is less than the nozzle length L.

Another embodiment of the present teachings hereof is a fused filament fabrication extrusion nozzle for use with an induction heating coil, which nozzle has a length L and an effective radius r, the nozzle comprising a material, such that, when the induction coil is driven at an induction frequency f, the nozzle has an induction skin depth s that is less than the effective radius r; and is larger than 1/15 of the effective radius r. The nozzle induction skin depth may be less than the nozzle length L. The nozzle material may comprise graphite. In addition to the nozzle, there may further be an induction heating coil. The coil has an inner radius, that is beneficially no greater than 1.4 times the nozzle body effective radius. The coil may also have an axial extent that is less than the nozzle length L.

Still another embodiment of the present teachings hereof is a printing assembly comprising a nozzle, having a length L and an effective radius r, the assembly also including and an induction heating coil, the coil being operable at an induction frequency f, such that, due to the nozzle material, at the induction frequency f, the nozzle has an induction skin depth. The nozzle induction skin depth s may be less than the effective radius r; and may be larger than 1/15 of the effective radius r; and may be less than the nozzle length L. The nozzle of the assembly may further have an annular outer body having an inner radius and a thickness, and an outer body outer effective radius equal to the effective radius r and an inner tube. The inner tube may be separable from the outer body. The nozzle may have a body, comprising a plurality of annular portions, at least one of which includes a bore, and is a first grade of graphite, and at least one of the annular portions comprising a second, different grade of graphite. The induction coil may have an inner radius that is beneficially no greater than 1.4 times the effective radius of the nozzle body. It is also beneficial if the induction coil has an axial extent that is less than L.

Yet another embodiment of the present teachings hereof is a nozzle for extruding a metal containing multi-phase (MCMP) build material, the nozzle being heated by induction heating established, by an induction coil, the nozzle comprising a nozzle material that has a higher performance index than that of the build material.

A method aspect of the present teachings hereof is a method for extruding, onto a build sheet, a metal containing multi-phase (MCMP) build material from a nozzle, the method comprising: providing a build sheet comprising a build sheet material; providing a MCMP build material; providing a nozzle having a body with a bore there-through, arranged with an inlet and an outlet, the outlet near to the build sheet, the nozzle body comprising a nozzle material, the materials having properties such that the nozzle material has a greater performance index than that of the build material; and extruding the build material from the nozzle onto the build sheet. The nozzle material typically has a greater performance index than that of the build sheet material.

Another aspect of the present teachings hereof is a printing assembly for extruding a metal containing multi-phase (MCMP) build material. The assembly comprises an induction coil and a nozzle, comprising a nozzle material that has a greater performance index than that of the build material. The induction coil may be arranged around the nozzle outer body and there may further be a magnetic flux controller that substantially surrounds the induction coil.

Another, similar aspect of the present teachings hereof is a printing assembly for extruding a metal containing multi-phase (MCMP) build material. The assembly comprises an induction coil and a build sheet and a nozzle, comprising a nozzle material that has a greater performance index than that of the build sheet material.

A related aspect of the present teachings hereof is a build platform unit upon which an object is to be built from metal containing multi-phase (MCMP) build material that is deposited on the build platform unit, from an extrusion nozzle, which nozzle is constructed from nozzle material having a performance index and can be heated by an induction coil driven at an induction frequency f. The build platform unit comprises: a build base and a build sheet. The build sheet: has a build sheet performance index; has a build sheet induction skin depth s at the induction frequency f and a thickness that is larger than the build sheet induction skin depth s; and is located closer to the induction coil than is the build base. There may further be an adhesion control layer located closer to the induction coil than is the build sheet. The adhesion control layer has a thickness, a skin depth at the induction frequency f, and a performance index, such that either: the adhesion control layer thickness is less than the skin depth at the induction frequency f; or, if the adhesion control layer thickness is larger than the skin depth at the induction frequency f; then, the adhesion control layer performance index is less than that of the nozzle material.

A method aspect of the present teachings hereof is a method of heating an extrusion nozzle near to a build platform unit upon which an object is to be built from metal containing, multi-phase (MCMP) build material that is deposited on the build platform unit, from the extrusion nozzle, which nozzle is constructed from a nozzle material having a performance index. The method comprises: inducing heat in the nozzle by operating the induction coil at an induction frequency f; and providing, near the nozzle, a build platform unit. The build platform unit may have a build base; and a build sheet. The build sheet: has a build sheet performance index; has a build sheet induction skin depth at the induction frequency f; is detachably attached to the build base; has a thickness that is larger than the build sheet induction skin depth; and is located closer to the induction coil than is the build base.

A final aspect of the present teachings hereof is an extrusion nozzle, having an inlet and an outlet and a bore there-between, the nozzle comprising: a body, comprising a plurality of annular portions; at least one of the annular portions comprising the bore, and being a first grade of graphite; and at least one of the annular portions comprising a second, different grade of graphite. This second grade of graphite may beneficially be copper infused graphite.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 shows schematically, in block diagram form, an additive manufacturing system.

FIG. 2 shows a phase diagram for a generic eutectic system, for which, within a temperature range, there are compositions that exist in a multi-phase condition of at least one solid phase and one liquid phase.

FIG. 3 shows, schematically, an extruder for fused filament fabrication additive manufacturing, with an inductively heated nozzle.

FIG. 4A shows a cylindrical extrusion nozzle in an induction coil where the axial length of the coil is similar to that of the nozzle and FIG. 4B shows a cross-sectional view of the nozzle of FIG. 4A along the lines B-B.

FIG. 5A shows a cylindrical extrusion nozzle and build material in an induction coil and illustrates the conductive heat transfer requirement and FIG. 5B shows a cross-sectional view of the nozzle of FIG. 5A along the lines B-B.

FIG. 6A shows a conical extrusion nozzle in an induction coil where the axial length of the coil is similar to that of the nozzle and FIG. 6B shows a cross-sectional view of the nozzle of FIG. 6A along the lines B-B.

FIG. 7A shows a cylindrical extrusion nozzle in an induction coil where the axial length of the coil is significantly less than that of the nozzle and FIG. 7B shows a cross-sectional view of the nozzle of FIG. 7A along the lines B-B.

FIG. 8A shows an embodiment of a multi-part extrusion nozzle and induction coil setup and FIG. 8B shows a cross-sectional view of the nozzle of FIG. 8A along the lines B-B.

FIG. 9 shows a 2D axisymmetric finite element simulation illustrating the approximate shape of the magnetic field strength within an embodiment of the nozzle.

FIG. 10A shows a cylindrical extrusion nozzle and an induction coil where the axial length of the coil is significantly less than that of the nozzle with a flux concentrator and FIG. 10B shows a cross-sectional view of the nozzle of FIG. 10A along the lines B-B.

FIG. 11 shows a 2D axisymmetric finite element simulation illustrating the approximate shape of the magnetic field strength within an embodiment of a nozzle using a flux concentrator

FIG. 12 shows a top view of a nozzle illustrating the ratio between the diameter of the build material, the outer diameter of the extrusion nozzle, and the inner diameter of induction coil.

FIG. 13 shows a material comparison plot on the basis of a performance index of the square root of the product of the electric resistivity and the relative magnetic permeability and several example materials are shown.

FIG. 14 shows some components of a build platform unit.

FIG. 15 shows a 2D axisymmetric finite element simulation illustrating the approximate shape of a magnetic field strength within an embodiment of a nozzle and a build platform unit, without a build sheet.

FIG. 16 shows a 2D axisymmetric finite element simulation illustrating the approximate shape of a magnetic field strength within an embodiment of a nozzle and a build platform unit, with a build sheet.

### DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

Described herein are devices, systems, and methods for induction heating systems and techniques for fused filament metal fabrication. Before that discussion, however, will be discussed the general FFF 3D printing equipment that is suitable for use with the present teachings. Mention will also be made of the materials for which benefits have been found using the techniques and apparatus disclosed herein.

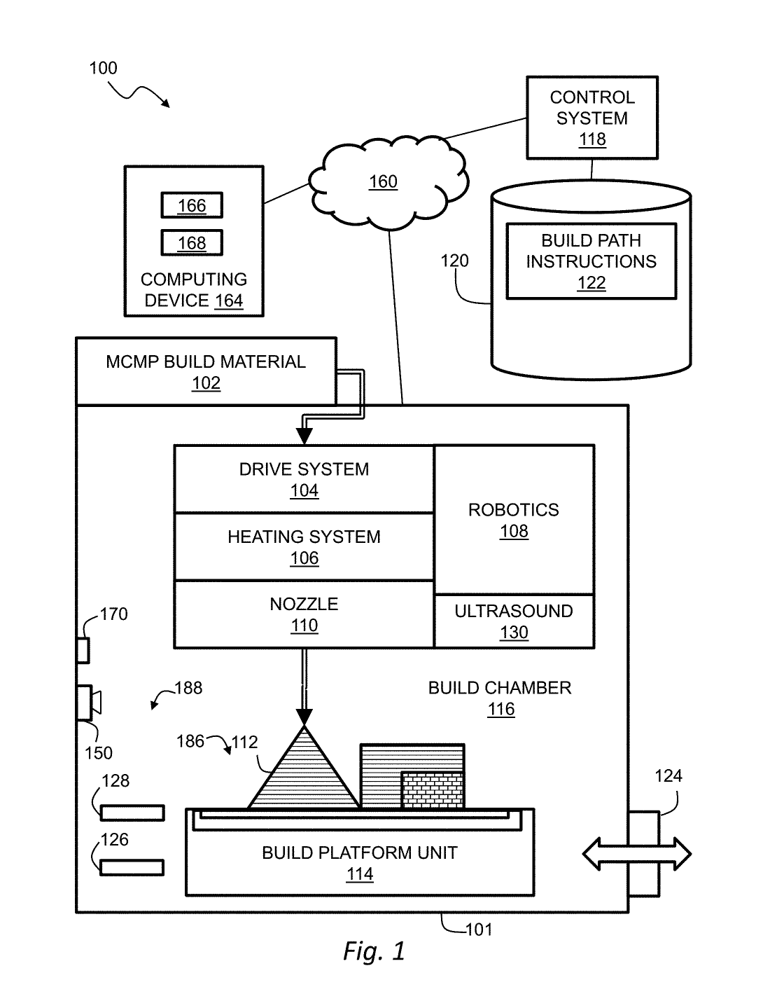

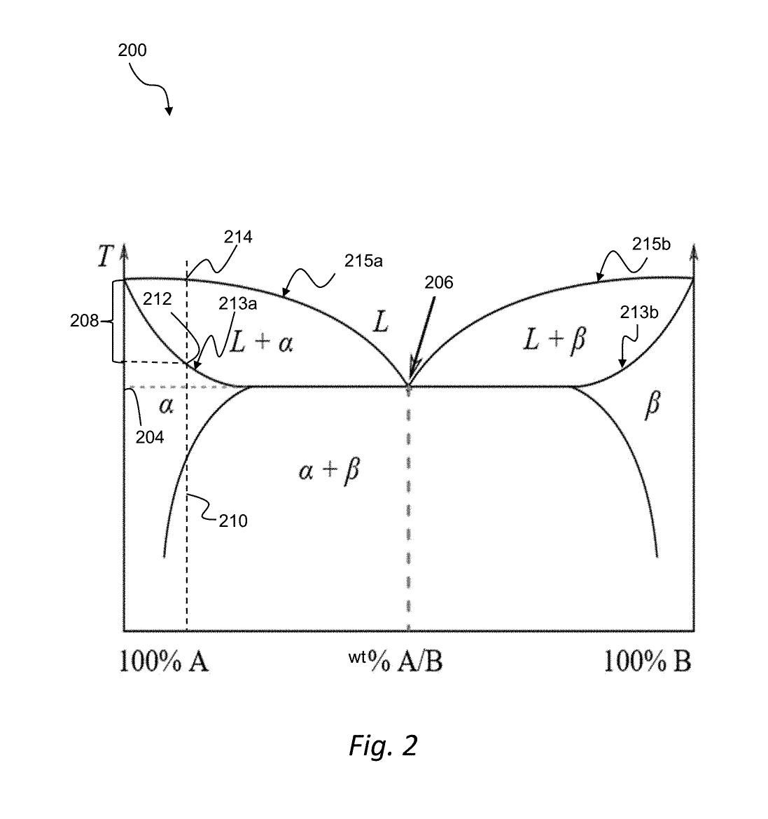

FIG. 1 is a schematic block diagram of an additive manufacturing system 100. In general, the additive manufacturing system may include a three-dimensional printer 101 (or simply printer 101) that deposits a metal, metal alloy, metal composite or the like, using fused filament fabrication or any similar process. In general, the printer 101 may include a multi-phase metallic build material 102 that is propelled by a drive system 104 and heated to an extrudable state by a heating system 106, and then extruded through one or more nozzles 110. By concurrently controlling robotics 108 to position the nozzle(s) along an extrusion path relative to a build platform unit 114, an object 112 may be fabricated on the build platform unit 114 which may be situated within a build chamber 116. In general, a control system 118 may manage operation of the printer 101 to fabricate the object 112 according to build path instructions 122 based on a three-dimensional model using a fused filament fabrication process or the like. FIG. 2 shows a phase diagram for one of the types of materials suitable as a build material and is discussed together with other types of suitable build material, below.

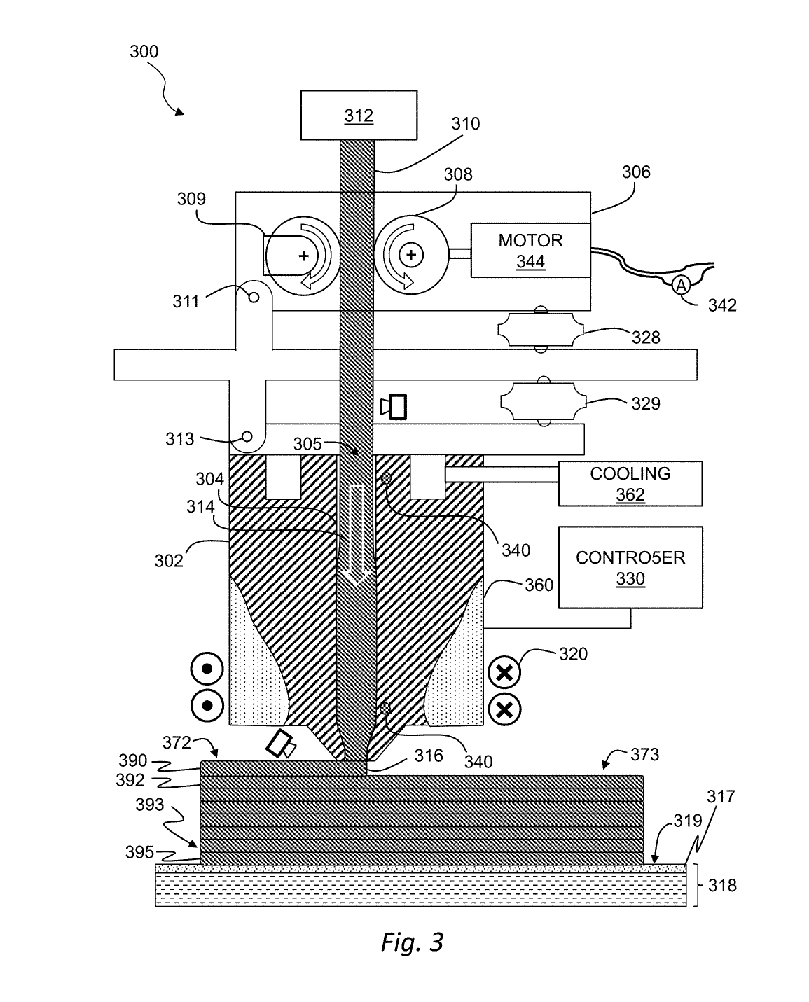

FIG. 3 shows an extruder 300 for a three-dimensional printer. In general, the extruder 300 may include a nozzle 302, a nozzle bore 304, a heating system 320, and a build material drive system 308 such as any of the systems described herein, or any other devices or combination of devices suitable for a printer that fabricates an object from a computerized model using a fused filament fabrication process and a metallic build material as contemplated herein. In general, the extruder 300 may receive a build material 310 from a source 312, such as any of the build materials and sources described herein, and advance the build material 310 along a feed path (indicated generally by an arrow 314) toward an opening 316 of the nozzle 302 for deposition on a build platform unit 318 or other suitable surface. The term build material is used herein interchangeably to refer to metallic build material, species and combinations of metallic build materials, or any other build materials, all as discussed below. As such, references to build material 310 should be understood to include metallic build materials, or multi-phase metallic build materials or any of the other build material or combination of build materials described herein, under specific conditions, unless a more specific meaning is provided or otherwise clear from the context.

Many metallic build materials may be used with the techniques described herein. In general, any build material with metallic content that provides a useful working temperature range with rheological behavior suitable for heated extrusion may be used as a metallic build material as contemplated herein. One useful class of metallic build materials are metallic multi-phase materials. Such multi-phase materials can be any wholly or partially metallic mixture that exhibits a working temperature range in which at least one solid phase and at least one liquid phase co-exist, resulting in a rheology suitable for fused filament fabrication or similar techniques described herein. Typically, build materials are processed at the nozzle operating temperature which is selected to fall within the working temperature range of the build material.

The term metal-containing multi-phase type material, referred to in shortened form as an MCMP type, or simply an MCMP material, will be used to refer to all of the materials that are about to be described, and any other suitable materials not explicitly mentioned, but which exhibits a working temperature range in which at least one solid phase and at least one liquid phase co-exist, resulting in a rheology suitable for fused filament fabrication or similar techniques described herein. Examples of these MCMP materials are described more fully in the U.S. application Ser. No. 16/038,057 mentioned and incorporated by reference above.

In one aspect, a MCMP build material may be a metal alloy that exhibits a multi-phase equilibrium between at least one solid and at least one liquid phase. Such a semi-solid state may provide a working temperature range with rheological behavior suitable for use in fused filament fabrication as contemplated herein. For example, the metal alloy may, within the working temperature range, form a non-Newtonian paste or Bingham fluid with a non-zero shear stress at zero shear strain. While the viscous fluid nature of the material permits extrusion or other similar deposition techniques, this non-Newtonian characteristic can permit the deposited material to retain its shape against the force of gravity so that a printed object can retain a desired form until the material cools below a solidus or eutectic temperature of the metallic base.

For example, a composition of a eutectic alloy system, which is not the eutectic composition, may exhibit such a multiphase equilibrium. Compositions within an alloy system with a eutectic may melt over a range of temperatures rather than at a melting point and thus provide a semi-solid state with a mixture of at least one solid and at least one liquid phase that collectively provide rheological behavior suitable for fused filament fabrication or similar additive fabrication techniques.

FIG. 2 shows a phase diagram 200 for a simple eutectic alloy system, exhibiting an alloy composition suitable for use as a MCMP build material in the methods and systems described herein. The eutectic composition is the composition present at the vertical dashed line that intersects the point 206. The point 206 is at the intersection of the lines that represent the eutectic composition (vertical dashed) and the eutectic temperature 204. In general, the build material may include an alloy with a working temperature range in which the mixture contains a solid and liquid phase in an equilibrium proportion dependent on temperature. The solid and liquid phases coexist within the temperature and composition combinations within the two bound regions labeled as L+α and L+β, respectively. This notation signifies that within that region, the build material exists as a mixture of a liquid phase L made up of components A and B and a solid phase with a specific crystalline structure. The solid phase is denoted as α, for compositions to the left of the eutectic composition (higher concentrations of component A) and as β for compositions to the right of the eutectic composition (higher concentrations of component B). Where α denotes a solid solution of B in an A matrix and β denotes a solid solution of A in a B matrix. This multi-phase condition usefully increases viscosity of the material above the pure liquid viscosity while in the working temperature range to render the material in a flowable state exhibiting rheological behavior suitable for fused filament fabrication or similar extrusion-based additive manufacturing techniques.

Also on the phase diagram 200, the composition and temperature combinations above the liquidus curves 215a and 215b will be a single liquid phase L. When an alloy in a eutectic alloy system solidifies, its components may solidify at different temperatures, resulting in a semi-solid suspension of solid and liquid components prior to full solidification. The working temperature for such an alloy composition is generally a range of temperatures between a lowest and highest melting temperature. In a mixture around the eutectic point 206, the lowest melting temperature (at which this mixture remains partially molten) is the eutectic temperature 204. The highest melting temperature will generally be a function of the percentage of the components A and B. In regions far from the eutectic composition such that the eutectic line terminates, i.e., at the far left or the far right of the phase diagram 200, the lowest melting temperature may be somewhat above the eutectic temperature, at the solidus temperature of the alloy composition. The solidus temperatures for different compositions lie upon the solidus curves 213a and 213b, which also are collinear for some of their extent with the eutectic line (i.e., the horizontal tie line at the eutectic temperature 204). For example, for a composition in a eutectic alloy system with a very high fraction of material A (as indicated by a dashed vertical line 210), the composition may have a solidus temperature 212 somewhat above the eutectic temperature 204, and a liquidus temperature 214 at the highest melting temperature for the composition. The composition may have a working temperature range 208 including a range of temperatures above a lowest melting temperature (e.g., where the entire system becomes solid) and below a highest melting temperature (e.g., where the entire system becomes liquid) where the composition, or a corresponding metallic build material includes solid and liquid phases in a combination providing a variable, temperature-dependent viscosity and rheological behavior suitable for extrusion. This working temperature range 208 will vary by composition and alloying elements, but may be adapted for a wide range of metal alloys for use in a fused filament fabrication process or the like as contemplated herein.

The metal alloy composition just described is one instance of a MCMP material of a general class of materials that are suitable for use with the present teachings hereof.

It should be understood that whenever alloy systems are discussed which have two constituents, that is, binary alloy systems, the same concepts will apply to alloy systems with three, four, and any number of constituents. As an example, a quaternary system can also have a eutectic composition.

Another instance of suitable MCMP materials may include compositions within a peritectic alloy system. A composition within a peritectic alloy system may also have a working temperature range with a multi-phase state suitable for use in a fused filament fabrication process.

Generally, a suitable MCMP material alloy system may contain more than one eutectic or more than one peritectic, as well as both eutectics and peritectics, all of which may provide a multi-phase state with a rheology suitable for extrusion. For example, the Al—Cu phase diagram (not reproduced herein) has both a eutectic and a peritectic. In particular the presence of intermediate phases and intermetallic compounds can greatly increase the complexity of metal alloy phase diagrams, resulting in multiple regions within the phase diagram where at least one liquid phase and at least one solid phase coexist in equilibrium. In such systems, there may be a wide range of alloy compositions exhibiting a working temperature range with a multi-phase state suitable for use as a metallic build material in a fused filament fabrication process. All of the foregoing are instances of suitable MCMP materials.

Yet another instance of suitable MCMP materials are isomorphous alloy systems.

More generally, a chemical system may exhibit a multi-phase equilibrium between at least one solid and at least one liquid phase without exhibiting a eutectic or a peritectic phase behavior. The copper-gold system is an example. Such systems may still provide a working temperature range between a solidus and liquidus temperature with a rheology suitable for use in fused filament fabrication process as contemplated herein, and such systems are considered an instance of MCMP materials.

Another instance of suitable MCMP materials include metallic materials using a combination of a metallic base and a high temperature inert second phase, which may constitute a metallic multi-phase material which may be usefully deployed as a build material for fused filament fabrication. For example, U.S. application Ser. No. 15/059,256, filed on Mar. 2, 2016 and incorporated by reference herein in its entirety, describes a variety of such materials. Thus, one useful metallic build material contemplated herein includes a composite formed of a metallic base and a second phase.

Another instance of suitable MCMP build materials includes a metal-loaded extrudable composite made up of a combination of a matrix material and metal particles. The matrix material may melt or undergo a glass-to-liquid-transition well below the melting temperature of the metal particles and thus provide a working temperature range in which the viscous fluid nature of the composite permits extrusion or other similar deposition techniques.

Still more generally, describing the overall concept of MCMP materials, they may include any build material with metallic content that provides a useful working temperature range with rheological behavior suitable for heated extrusion and thus may be used as a metallic build material as contemplated herein. Examples have been given above. The limits of this window or range of working temperatures will depend on the type of material (e.g. metal alloy, metallic material with high temperature inert phase, metal-loaded extrudable composites) and the metallic and non-metallic constituents. For metal alloys, such as compositions in eutectic alloy systems, peritectic alloy systems and isomorphous alloy systems, the useful temperature range is typically between a solidus temperature and a liquidus temperature. In this context, the corresponding working temperature range is referred to for simplicity as a working temperature range between a lowest and highest melting temperature. For MCMP build materials with an inert high temperature second phase, the window may begin at any temperature above the melting temperature of the base metallic alloy, and may range up to any temperature where the second phase remains substantially inert within the mixture. For MCMP metal-loaded extrudable composites, the window may begin at any temperature above the glass transition temperature for amorphous matrix materials or above the melting temperature for crystalline matrix materials, and may range up to any temperature where the thermal decomposition of the matrix material remains sufficiently low.

According to the foregoing, the term MCMP build material, as used herein, is intended to refer to any metal-containing build material, which may include elemental or alloyed metallic components, as well as compositions containing other non-metallic components, which may be added for any of a variety of mechanical, rheological, aesthetic, or other purposes. For non-limiting example, non-metallic strengtheners may be added to a metallic material.

Much of the discussion above has centered around metal alloy systems containing as few as two elements. The present teachings disclosed herein may apply to metal alloy systems with any number of elements. Examples of commercial alloys which are relevant include the following: Zinc die-casting alloys such as Zamak 2, Zamak 3, Zamak 5, Zamak 7, ZA-8, ZA-12, ZA-27. Magnesium die casting alloys such as AZ91 Aluminum casting alloys such as A356, A357, A319, A360, A380. Aluminum wrought alloys such as 6061, 7075.

It is useful to return to a more detailed discussion of apparatus and methods used to treat and build objects with such build materials. FIG. 1 is a block diagram of an additive manufacturing system. In general, the additive manufacturing system may include a three-dimensional printer 101 (or simply printer 101) that deposits a metal, metal alloy, metal composite or the like using fused filament fabrication or any similar process. In general, the printer 101 may include one or more build materials 102 which are propelled by one or more drive systems 104 and heated to an extrudable state by one or more heating systems 106, and then extruded through one or more nozzles 110. By concurrently controlling robotics 108 to position the nozzle(s) along an extrusion path relative to a build platform unit 114, an object 112 may be fabricated on the build platform unit 114 which may be situated within a build chamber 116. In general, a control system 118 may manage operation of the printer 101 to fabricate the object 112 according to a three-dimensional model using a fused filament fabrication process or the like.

The build material 102 may be provided in a variety of form factors including, without limitation, any of the form factors described herein or in materials incorporated by reference herein. The build material 102 may be provided, for example, from a hermetically sealed container or the like (e.g., to mitigate oxidation and other undesirable reactions with the environment), as a continuous feed (e.g., a wire). In one aspect, two build materials 102 may be used concurrently, e.g., through two different nozzles.

The build material 102 may include a metal wire, such as a wire with a diameter of approximately 80 μm, 90 μm, 100 μm, 0.5 mm, 1 mm, 1.25 mm, 1.5 mm, 1.75 mm, 2 mm, 2.25 mm, 2.5 mm, 3 mm, or any other suitable diameter.

The build material 102 may have any shape or size suitable for extrusion in a fused filament fabrication process.

A printer 101 disclosed herein may include a first nozzle 110 for extruding a first material. The printer 101 may also include a second nozzle for extruding a second material with the same or different mechanical, functional, or aesthetic properties useful for fabricating a multi-material object.

A drive system 104 may include any suitable gears, rollers, compression pistons, or the like for continuous or indexed feeding of the build material 102 into the heating system 106.

The heating system 106 may employ a variety of techniques to heat a metallic build material to a temperature within a working temperature range suitable for extrusion. Suitable heating techniques may for instance include inductive heating which is discussed in more detail further below. For fused filament fabrication systems as contemplated herein, the working temperature range is more generally a range of temperatures where a build material exhibits rheological behavior suitable for fused filament fabrication or a similar extrusion-based process. These behaviors are generally appreciated for, e.g., thermoplastics such as ABS or PLA used in fused deposition modeling, however many metallic build materials have similarly suitable behavior, albeit many with greater forces and higher temperatures, for heating, deformation and flow through a nozzle so that they can be deposited onto an object with a force and at a temperature to fuse to an underlying layer. Among other things, this requires a plasticity at elevated temperatures that can be propelled through a nozzle for deposition (at time scales suitable for three-dimensional printing), and a rigidity at lower temperatures that can be used to transfer force downstream in a feed path to a nozzle bore or reservoir where the build material can be heated into a flowable state and forced out of a nozzle.

Any heating system 106 or combination of heating systems suitable for maintaining a corresponding working temperature range in the build material 102 where and as needed to drive the build material 102 to and through the nozzle 110 may be suitably employed as a heating system 106 as contemplated herein. Particularly useful nozzle apparati and methods of using such nozzles having mechanisms for both heating (adding thermal power to) the nozzle outlet and cooling its inlet, and even the opposite (providing thermal power to the inlet and removing thermal power from (cooling) the nozzle outlet are disclosed in U.S. patent application Ser. No. 16/035,296, mentioned and incorporated by reference, above.

The robotics 108 may include any robotic components or systems suitable for moving the nozzles 110 in a three-dimensional path relative to the build platform unit 114 while extruding build material 102 to fabricate the object 112 from the build material 102 according to a computerized model of the object. A variety of robotics systems are known in the art and suitable for use as the robotics 108 contemplated herein. For example, the robotics 108 may include a Cartesian coordinate robot or x-y-z robotic system employing a number of linear controls to move independently in the x-axis, the y-axis, and the z-axis within the build chamber 116. Delta robots may also or instead be usefully employed. Other configurations such as double or triple delta robots can increase range of motion using multiple linkages. More generally, any robotics suitable for controlled positioning of a nozzle 110 relative to the build platform unit 114 may be usefully employed, including any mechanism or combination of mechanisms suitable for actuation, manipulation, locomotion, and the like within the build chamber 116.

The robotics 108 may position the nozzle 110 relative to the build platform unit 114 by controlling movement of one or more of the nozzle 110 and the build platform unit 114. The object 112 may be any object suitable for fabrication using the techniques contemplated herein. The build platform unit 114 may include any surface or substance suitable for receiving deposited metal or other materials from the nozzles 110.

The build platform unit 114 may be movable within the build chamber 116, e.g., by a positioning assembly (e.g., the same robotics 108 that position the nozzle 110 or different robotics). For example, the build platform unit 114 may be movable along a z-axis (e.g., up and down—toward and away from the nozzle 110), or along an x-y plane (e.g., side to side, for instance in a pattern that forms the tool path or that works in conjunction with movement of the nozzle 110 to form the tool path for fabricating the object 112), or some combination of these. In an aspect, the build platform unit 114 is rotatable. The build platform unit 114 may include a temperature control system for maintaining or adjusting a temperature of at least a portion of the build platform unit 114.

In general, an optional build chamber 116 houses the build platform unit 114 and the nozzle 110, and maintains a build environment suitable for fabricating the object 112 on the build platform unit 114 from the build material 102.

The printer 101 may include a vacuum pump 124 coupled to the build chamber 116 and operable to create a vacuum within the build chamber 116. The build chamber 116 may form an environmentally sealed chamber so that it can be evacuated with the vacuum pump 124 or any similar device in order to provide a vacuum environment for fabrication. The environmentally sealed build chamber 116 can be purged of oxygen and water, or filled with one or more inert gases in a controlled manner to provide a stable build environment. Thus, for example, the build chamber 116 may be substantially filled with one or more inert gases such as argon or any other gases that do not interact significantly with heated metallic build materials 102 used by the printer 101.

In general, a control system 118 may include a controller or the like configured to control operation of the printer 101. The control system 118 may be operable to control the components of the additive manufacturing system 100, such as the nozzle 110, the build platform unit 114, the robotics 108, the various temperature and pressure control systems, and any other components of the additive manufacturing system 100 described herein to fabricate the object 112 from the build material 102 according to build path instructions 122 based on a three-dimensional model or any other computerized model describing the object 112 or objects to be fabricated. The control system 118 may include any combination of software and/or processing circuitry suitable for controlling the various components of the additive manufacturing system 100 described herein including without limitation microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and the like.

In general, build path instructions 122 or other computerized model of the object 112 may be stored in a database 120 such as a local memory of a computing device used as the control system 118, or a remote database accessible through a server or other remote resource, or in any other computer-readable medium accessible to the control system 118. The control system 118 may retrieve particular build path instructions 122 in response to user input, and generate machine-ready instructions for execution by the printer 101 to fabricate the corresponding object 112.

In operation, to prepare for the additive manufacturing of an object 112, a design for the object 112 may first be provided to a computing device 164. The design may include build path instructions 122 of a three-dimensional model included in a CAD file or the like.

The computing device 164 may include the control system 118 as described herein or a component of the control system 118. The computing device 164 may also or instead supplement or be provided in lieu of the control system 118. Thus, unless explicitly stated to the contrary or otherwise clear from the context, any of the functions of the computing device 164 may be performed by the control system 118 and vice-versa. In another aspect, the computing device 164 is in communication with or otherwise coupled to the control system 118, e.g., through a network 160.

The computing device 164 (and the control system 118) may include a processor 166 and a memory 168 to perform the functions and processing tasks related to management of the additive manufacturing system 100 as described herein.

One or more ultrasound transducers 130 or similar vibration components may be usefully deployed at a variety of locations within the printer 101. As discussed below, a nozzle service region 188 is spaced away from the object build region 186 where the object is fabricated. The nozzle service region is where at least some service operations are conducted. It may include one or more cameras 150 or other optical or visual devices, other sensors 170, waste material receptacles 128, additional heating and cooling apparatus 126, as well as any items or supplies that may be used to service the nozzle and other parts of the device.

FIG. 3 shows an extruder 300 for a three-dimensional printer. In general, the extruder 300 may include a nozzle 302, a nozzle bore 304, a heating system 320, and a drive system 308 such as any of the systems described herein, or any other devices or combination of devices suitable for a printer that fabricates an object from a computerized model using a fused filament fabrication process and a metallic build material as contemplated herein. In general, the extruder 300 may receive a build material 310 from a source 312, such as any of the build materials and sources described herein, and advance the build material 310 along a feed path (indicated generally by an arrow 314) toward an opening 316 of the nozzle 302 for deposition on a build platform unit 318 or other suitable surface. The term build material is used herein interchangeably to refer to metallic build material, species and combinations of metallic build materials, or any other build materials. As such, references to build material 310 should be understood to include metallic build materials, or multi-phase metallic build materials or any of the other build material or combination of build materials described herein, under specific conditions, unless a more specific meaning is provided or otherwise clear from the context.

The nozzle 302 may be any nozzle suitable for the temperatures and mechanical forces required for the build material 310. For extrusion of metallic build materials, portions of the nozzle 302 (and the nozzle bore 304) may be formed of high-temperature materials such as sapphire, alumina, aluminum nitride, graphite, boron nitride or quartz, which provide a substantial margin of safety for system components. In the context of using induction heating as one of the heating techniques for the extrusion nozzle 302, additional guidelines for material selection and design of the extrusion nozzle 302 are provided further below.

The nozzle bore 304 may be any chamber or the like suitable for heating the build material 310, and may include an inlet 305 to receive a build material 310 from the source 312. The nozzle 302 may also include an outlet 316 that provides an exit path for the build material 310 to exit the nozzle bore 304 along the feed path 314 where, for example, the build material 310 may be deposited in a segment (also referred to herein and in the industry as a road, bead, or line) on the build platform unit 318. The inside dimensions of the nozzle bore may be larger than the outside dimensions of the incoming build material, and thus could be said to have some amount of clearance or extra volume with respect the build material. It should also be noted that the nozzle bore may take a wide array of geometries and cross-sections and need not be uniform along its length. For example, it may include diverging sections, converging sections, straight sections, and non-cylindrical sections. Subsequent layers of lines are deposited upon an earlier layer 392. The layer presently being deposited as the top layer 390 has an exposed upper surface 372, upon which the next to be deposited layer will be deposited.

The heating system 320 may employ any of the heating devices or techniques described herein. It will be understood that the heating system 320 may also or instead be configured to provide additional thermal control, such as by locally heating the build material 310 where it exits the nozzle 302 or fuses with a second layer 392 of previously deposited material, or by heating a build chamber or other build environment where the nozzle 302 is fabricating an object. The temperature of the nozzle 302 may be measured with one or more temperature measuring devices 340. Optionally, forced gas cooling 362 may be applied near the nozzle inlet. An auxiliary heater (not shown) may be provided relatively close to the inlet 305, for times when it may be desired to add thermal power to the nozzle near to the inlet.

The drive system 308 may be any drive system operable to mechanically engage the build material 310 in solid form and advance the build material 310 from the source 312 into the nozzle bore 304 with sufficient force to extrude the build material 310, while at a temperature within the working temperature range, through the opening 316 in the nozzle 302. In general, the drive system 308 may engage the build material 310 while at a temperature below the working temperature range, e.g., in solid form, or at a temperature below a bottom of the working temperature range where the build material 310 is more pliable but still sufficiently rigid to support extrusion loads and translate a driving force from the drive system 308 through the build material 310 to extrude the heated build material in the nozzle bore 304.

A sensor, such as a load cell 328, or a torque sensor 309, may be coupled to the drive system 308, to sense the load on the drive system. This can be useful, for instance, to determine whether any blockages or other impediments to driving the build material may be occurring. In one embodiment, the drive assembly 306 is allowed to pivot about point 311 and the load cell 328 provides the reaction force. Additionally, a sensor 329 can be provided that measures the force exerted by build material 310 within and exiting the nozzle outlet 316 upon the nozzle 302. For instance, a load cell 329 can measure the force of the build material pushing on the entire nozzle 302. In one embodiment, the nozzle assembly is allowed to pivot about point 313 and the load cell 329 provides the reaction force.

Alternatively, a torque sensor can be included within the drive mechanism to sense the torque on the driving apparatus, such as wheels or gears. The current that any motor used to power the drive system is related to the force that the drive system encounters. Therefore, the current drawn by the drive motor 344 can be monitored via sensor 342, with an increase in current indicating an increase in power needed to drive the build material into the nozzle inlet and thereby inferring the extrusion force. The motor 344 is mechanically engaged with build material drive system 308.

As discussed below, the forces measured by the various sensors can be compared, or combined, or otherwise analyzed to assess whether or not a flow artifact is present or forming.

The extruder 300 may also include a controller 330, for controlling various components of the extruder, including the cooling 362, heating 320 and taking various inputs including temperatures 340 and forces 328, 329.

Unlike thermoplastics conventionally used in fused filament fabrication, metallic build materials are highly thermally conductive. As a result, high nozzle temperatures can contribute to elevated temperatures in the drive system 308. Thus, in one aspect, a lower limit of the working temperature range for the nozzle bore 304 and nozzle 302 may be any temperature within the temperature ranges described above that is also above a temperature of the build material 310 where it engages the drive system 308, thus providing a first temperature range for driving the build material 310 and a second temperature range greater than the first temperature range for extruding the build material 310. Or stated alternatively and consistent with the previously discussed working temperature ranges, the build material 310 may typically be maintained within the working temperature range while extruding and below the working temperature range while engaged with the drive system 308, however, in some embodiments the build material 310 may be maintained within the working temperature when engaged with the drive system 308 and when subsequently extruded from by the nozzle 302. All such temperature profiles consistent with extrusion of metallic build materials as contemplated herein may be suitably employed. While illustrated as a gear, it will be understood that the drive system 308 may include any of the drive chain components described herein, and the build material 310 may be in any suitable, corresponding form factor.

As noted above, a printer may include two or more nozzles and extruders for supplying multiple build and support materials or the like. Thus, the extruder 300 may be a second extruder for extruding a supplemental build material.

In conventional polymer FFF, most build materials can be extruded at temperatures below 300° C. These modest temperature requirements allow the use of resistive heating as a cost-effective solution to supply the thermal power for extrusion. In contrast, FFF of metallic materials requires temperatures that are much higher than those required for polymers. But more than just the higher operating temperatures, variations in the thermal load due to, for instance, variations in extrusion rate during a print, impose a need for fast and efficient delivery of large amounts of thermal power into the extrusion nozzle. This is further exacerbated by the higher thermal conductivities of metal build materials compared to polymer build materials. These requirements make induction heating, rather than resistive heating, advantageous for FFF of metal build materials.

Induction heating may prove advantageous for several reasons. It is a non-contact heating solution, alleviating concerns of heater mounting, thermal contact, degradation, and maximum operating temperature. While absolute efficiency is lower than that for purely resistive heating, achievable power densities may be higher, because the object to be heated (the nozzle, in this case), which can be thought of generically as a workpiece to be heated, is heated directly, in a volumetric sense. The power density for induction heating is bounded on the upper end by the power supply and the ability to sufficiently cool the induction coil material from self-heating. Commercially, induction heating power supplies may span into tens or even hundreds of kilowatts of power.

Furthermore, the temperature stability of an inductively heated extrusion nozzle may be much better than the stability of a resistively heated nozzle. Resistive heating elements may require electrical insulation between themselves and electrically conductive substrates, such as many of the nozzle materials contemplated herein, to prevent potentially electrically shorting the heating elements. The electrical insulation may introduce its own heat capacity to the system. Furthermore, the electric insulators are often quite thermally resistive, which negatively impacts the heat transfer from the elements to the nozzle. These effects combine such that even after the complete removal of electrical power from a resistive heating element, there is the potential for the mean temperature of the extrusion nozzle to increase further. Since the temperature in the resistive elements is typically higher than the temperature of the nozzle, thermal power continues to flow through the insulation and into the nozzle until equilibrium is reached. Whereas, an induction heater, even though it is electrically conductive, will not require such electrical insulation, because the induction heater does not require physically, and thus, electrical, contact to the object to heat it. Thus, when electrical power is cut from an induction heater, the addition of thermal power ceases nearly instantaneously and the mean temperature of the nozzle cannot increase. There are no electrical insulators complicating the thermal system response. A similar situation would exist on startup, allowing an induction heater to supply thermal power to the extrusion nozzle as soon as electrical power is applied. Therefore, induction heating can lead to a more controllable extrusion system.

An induction heating system typically consists of a power supply and an induction coil. The power supply applies an alternating voltage to the induction coil. The alternating electric field has a frequency, also referred to as the induction frequency, and drives an alternating current through the induction coil. The alternating current flowing through the induction coil generates an alternating magnetic field of the same frequency, according to Ampere's law. For instance, for a current flowing through a conductor in free space, the resulting magnetic field circles around the current and is given by:

[symbol]

Bdl=μ₀I_{c} (1).

Here, I_{c} is the current flowing through the conductor, B denotes the magnetic field generated by the current, and μ₀ is the permeability of free space.

The process of induction heating can be broken up into three principle steps, and can be understood with reference to FIG. 3. First, energy is transferred from the induction coil to the workpiece (e.g., the piece of material to be heated) by means of an electromagnetic field (e.g., the induction field). Second, in the workpiece, the electromagnetic energy is transformed into heat. And third, the generated heat is distributed inside the workpiece via thermal conduction.

For the case of metal FFF, it is ultimately the build material that is to be heated, however in many cases heating the build material directly is impractical, and it is thus preferred to heat the build material indirectly by use of a susceptor. A susceptor extrusion nozzle or a susceptor that is part of the extrusion nozzle 302 is inductively heated, which then indirectly heats up the build material 310 as it passes through the nozzle (through conductive and radiative heat transfer, for example). The extrusion nozzle 302 may consist of a single element or an assembly of multiple elements and includes a susceptor, an inlet 305 to receive build material 310, an outlet 316 by which the build material, in the form of an extrudate, is extruded, and a nozzle bore 304 connecting the inlet and outlet. In some cases, the entire extrusion nozzle may act as the susceptor, whereas in other cases only a part of the nozzle may act as a susceptor for the induction field. The extrusion nozzle may also include additional elements, such as those for material guidance, thermal insulation, oxidation prevention, and mounting features, for example.

Using a susceptor, as compared to directly inducing heat in the build material, is advantageous for several reasons. Firstly, it may provide improved temperature control and the ability to vary the temperature profile the nozzle and thus the build material. In steady state, the build material will asymptotically approach, but not exceed, the temperature of walls of the nozzle bore. By measuring and controlling the temperature of the nozzle bore (or the temperature of a region of the nozzle body in close proximity to the nozzle bore, such as near to temperature sensors 340), the temperature of the build material is bounded. Whereas, if the induction heating were to be coupled directly to the build material without a susceptor, then there would be a greater propensity for the temperature of the build material to overshoot a target temperature, because there is no hard limit to the temperatures achievable via self-heating. The heat capacity of the build material is typically much smaller than the heat capacity of the extrusion nozzle itself, making the build material much more sensitive to rapid variations in thermal power input or loss. Also, direct measurement of the temperature of the build material is challenging due to, for example, its location within the nozzle, rapid movement of the build material, and multi-phase nature. Moreover, the material properties of the build material may undergo significant changes upon partial or full melting, which, as described below, can have a large effect on the thermal power generated via induction heating. A system where induction field directly heats the build material would therefore face significant challenges in temperature control and would need to be heavily reliant on closed loop control.

To efficiently transfer energy from the induction coil into the extrusion nozzle, the nozzle and more specifically the susceptor of the nozzle should beneficially be in close proximity to the induction coil. The alternating magnetic field produced by the nearby induction coil 320 results in an alternating magnetic flux in the nozzle 302 which induces an electromotive force in the nozzle, according to Faraday-Lenz's Law:

$$U = - \frac{d Φ}{dt} . \qquad ( 2 )$$

Here, U is the induced electromotive force, t is the time and D is the alternating magnetic flux through the extrusion nozzle susceptor. The magnetic flux depends on the strength of the magnetic field generated by the induction coil 320, as well as the relative magnetic permeability of the susceptor material.

Depending on the material properties of the susceptor of the nozzle, there exist two distinct mechanisms through which the electromagnetic energy provided by the induction coil is transformed into heat. First, if the susceptor is electrically conductive, the induced electromotive force generates eddy currents in the susceptor. As indicated by Faraday-Lenz's law, the eddy currents oppose the change in magnetic flux that gave rise to them and result in Joule heating in the susceptor due to resistive power losses. Second, if the extrusion nozzle's susceptor is ferromagnetic or ferrimagnetic, heat can also be generated via hysteresis losses. The alternating magnetic field produced by the induction coil drives magnetization reversal, which requires a rearrangement of the magnetic microstructure of these materials and thus produces heat. The hysteresis losses, produced during each magnetization cycle of the material, is given by the area of the hysteresis loop.

Ferromagnetic and ferrimagnetic materials exhibit a relative magnetic permeability, μᵣ, much greater than one. If these types of materials are used, a detailed analysis based upon the field strength and expected temperatures may be required, due to the complex behavior of the relative magnetic permeability. The values presented herein have been taken as often cited initial relative magnetic permeabilities at room temperature. At a temperature that is known as the Curie temperature, these materials lose their ferromagnetic or ferrimagnetic nature and μᵣ declines substantially. The behavior of μᵣ for a given material over a range of temperatures and magnetic field strengths may be complex, however, generally, magnetic materials may retain a substantial μᵣ even for temperatures close to and slightly below their Curie temperature. Hysteresis losses only contribute to induction heating while the material remains ferromagnetic or ferrimagnetic. If the susceptor material is electrically conductive, once the material is heated above its Curie temperature, there are no more hysteresis losses and Joule heating is the main contributor to induction heating in the susceptor of the extrusion nozzle.

To achieve an efficient energy transfer from the induction coil to the susceptor of the extrusion nozzle, it is important that the coil and susceptor are magnetically tightly coupled. This can be expressed through a so-called magnetic coupling coefficient. The coupling coefficient depends only on the geometry of the induction coil and the susceptor and denotes the fraction of magnetic flux generated by the induction coil that is linked with the susceptor. The coupling coefficient can take values between zero, for which none of the magnetic flux generated by the induction coil is linked to the susceptor, and one, for which all the magnetic flux generated by the induction coil is linked to the susceptor.

The coupling coefficient can be maximized by closely matching the geometry of the induction coil to the geometry of the susceptor of the extrusion nozzle. Take for instance, a cylindrically shaped extrusion nozzle with length L_{w}, outer diameter d_{w}, and bore diameter d_{b}, placed inside a cylindrical induction coil with a length L_{c} and an inner diameter d_{c}. Under the assumption that the entirety of the extrusion nozzle acts as the susceptor and that d_{b} is small compared to d_{w}, the coupling coefficient tends to unity as d_{c} approaches d_{w} and L_{c} approaches L_{w}. It is therefore desirable to select an induction coil and extrusion nozzle combination such that the inner diameter d_{c} of the induction coil is approximately equal to the outer diameter d_{w} of the nozzle's susceptor. Or more generally, the combination of induction coil and nozzle susceptor should be selected such that any gaps between the susceptor and the induction coil are minimized.

For a nozzle susceptor made from an electrically conductive material, the induced current is not uniformly distributed throughout the susceptor. Due to an effect known as the skin effect, the current density is largest at the surface of the susceptor and decreases approximately exponentially with increasing depth from the surface, according to:

j_{w}=jₛe^{-w/δ} (3).

Here, j_{w} is the induced current density, jₛ is the induced current density at the surface of the susceptor, w is the depth from the surface and δ is the so-called skin depth. The skin depth is defined as the depth from the surface at which the current density decays to 37% of its value at the surface or equivalently where 86% of the power is dissipated.

For a nozzle susceptor made of a good electrical conductor, the skin depth δ is given approximately by:

$$δ = \sqrt{\frac{ρ}{π {μ}_{0} {μ}_{r} f}} . \qquad ( 4 )$$

where μ₀ is the magnetic permeability of free space, is the relative magnetic permeability of the susceptor material, ρ is the electrical resistivity of the susceptor material and f is the induction frequency.

As can be seen from Eq. 4 above, the skin depth would be relatively smaller with relatively larger induction frequency, relatively larger relative magnetic permeability, and relatively smaller electrical resistivity. Thus, at a given induction frequency, the skin depth can vary widely in different materials, as illustrated in the table below for a range of relevant materials at an induction frequency of 100 kHz.

| Material | ρ (μOhm * cm) | μᵣ | δ (mm) |
|---|---|---|---|
| Aluminum | 2.65 | ~1 | 0.26 |
| Aluminum alloy A356 | 4.40 | ~1 | 0.33 |
| Zinc-Aluminum | 6.10 | ~1 | 0.39 |
| Copper | 1.68 | ~1 | 0.21 |
| Stainless Steel AISI 316 | 74 | ~1 | 1.37 |
| Stainless Steel AISI 420 | 55 | 950 | 0.04 |
| Isotropic graphite | 1300 | ~1 | 5.70 |
| Copper infiltrated graphite | 323 | ~1 | 2.86 |

Electrical resistivity and relative magnetic permeability are temperature dependent material properties, and thus, the skin depth may also vary with temperature. The information presented in the above table is at room temperature. The skin depth of these materials may change significantly while they are heated via induction heating. Since in metal FFF the temperature of the extrusion nozzle remains within an operating range for the vast majority of a print time, the induction heating process may be optimized based on the material properties at the operating temperature.

Beyond governing the skin depth, the electrical resistivity and relative magnetic permeability also govern the geometry and induction frequency at which the susceptor of the extrusion nozzle can best be heated. For example, for the cylindrically shaped and electrically conductive extrusion nozzle described above, the power dissipated into the nozzle through Joule heating can be approximately calculated as follows.

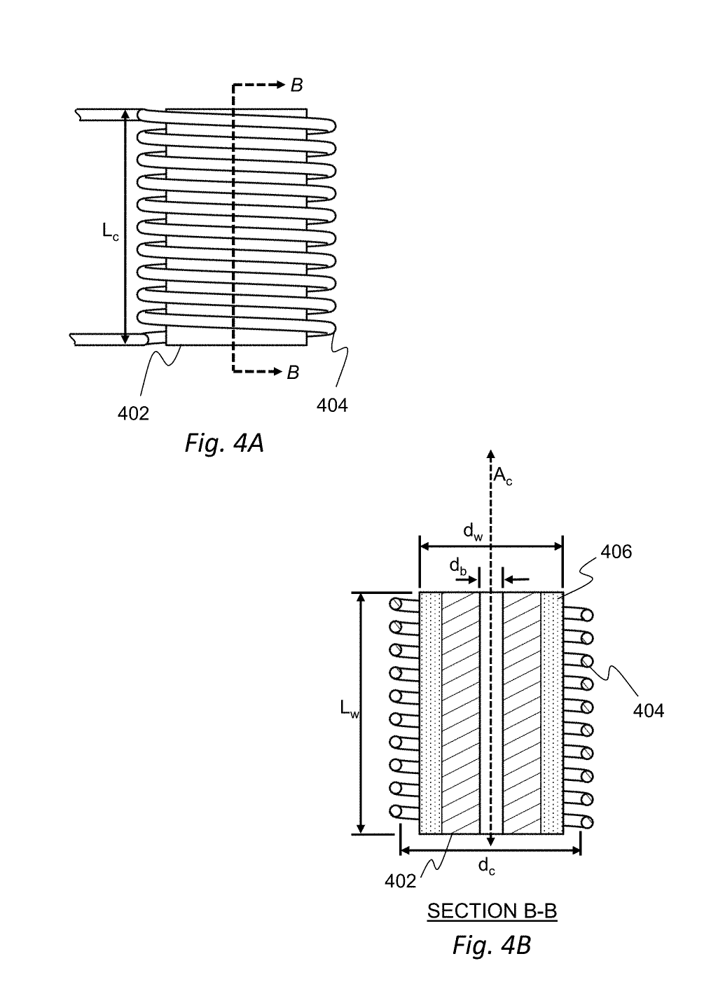

As in the above example, it is assumed in the following that the entirety of the nozzle acts as a susceptor and the diameter of the nozzle bore d_{b} is small compared to the outer diameter d_{w} of the nozzle. FIG. 4A and the associated cross-sectional view in FIG. 4B shows the relevant extrusion nozzle and induction coil arrangement. Assume the extrusion nozzle 402 with an outer diameter d_{w}=2r_{w} and length L_{w} is placed inside an induction coil 404 with inner diameter d_{c}, length L_{c} and N_{c} coil turns, such that the coil and the nozzle are magnetically tightly coupled (e.g., coupling coefficient of one). The magnetic field within the inside diameter of the coil is predominantly oriented in the direction parallel to the axis A_{c} of the coil 404 and the current I_{w} induced in the nozzle 402 can be expressed as:

I_{w}=N_{c}I_{c} (5).

Here the N_{c} is the number of turns on the induction coil 404 and I_{c} is the current flowing through the induction coil 404. It is further assumed that all of the induced current I_{w} flows only within one skin depth 406 from the surface of the nozzle 402 and the skin depth is small compared to the radius of the nozzle r_{w} and constant over the length of nozzle L_{w}. Then the equivalent current path is approximately given by the cross section δL_{w} and length 2πr_{w}. The resistance R_{w} of the equivalent current path can be expressed as:

$${R}_{w} = ρ \frac{π {d}_{w}}{δ {L}_{w}} . \qquad ( 6 )$$

The power dissipated by Joule heating in the nozzle can then be expressed by:

$${P}_{w} = {I}_{w}^{2} {R}_{w} = {I}_{c}^{2} {N}_{c}^{2} ρ \frac{π {d}_{w}}{δ {L}_{w}} = {I}_{c}^{2} {N}_{c}^{2} {π}^{3 / 2} \sqrt{{μ}_{0} {μ}_{r} ρ f} \frac{dw}{{L}_{w}} . \qquad ( 7 )$$

Here, it can be seen that the dissipated power in the extrusion nozzle is relatively larger with relatively larger: induction frequency f; relative magnetic permeability μᵣ: and electrical resistivity ρ of the nozzle material. Below, the square root of the product of relative magnetic permeability and electrical resistivity is referred to as the performance index and provides a measure to distinguish and compare different materials by their propensity to be induction heated via Joule heating. Here, a performance index of the nozzle can be defined based on the assumption that the entirety of the nozzle acts as a susceptor. It is understood that in cases where this assumption does not hold and the susceptor represents only a part of the nozzle, the term nozzle performance index refers to the performance index of the nozzle susceptor.

According to Eq. 7, for a given nozzle material, the nozzle geometry and induction frequency are two of the parameters that can be selected to optimize the induction heating process for an extrusion nozzle.

For a given nozzle diameter, the induction frequency can be optimized. According to Eq. 7 above, induction heating exhibits only a weak dependence on the induction frequency f. The dissipated power varies as f^{1/2}. However, Eq. 7 only applies to high induction frequencies, e.g., in the limit where the skin depth δ (Eq. 4 above) is much smaller than the radius of the extrusion nozzle r_{w}. Thus, Eq. 7 does not depict the entire situation, and thus, the variation of power with f^{1/2} does not always arise. By contrast, for low induction frequencies (for example where δ>r_{w}) the dissipated power exhibits a much stronger dependence on frequency and varies approximately with f². This difference in the frequency dependence shows that while a relatively larger induction frequency is beneficial up to a point, frequency higher than this point would not produce much additional heating. In very cost sensitive circumstances, it may also be desirable from a purely economic standpoint to heat the extrusion nozzle at induction frequencies below this transition point, however overall electric efficiency may suffer.

For a chosen susceptor material and geometry, it is possible to define an optimal induction frequency from a volumetric power density standpoint (i.e., Watts per cubic meter). For the cylindrical nozzle, the transition point discussed above occurs approximately at an induction frequency corresponding to a skin depth approximately equal to twice the radius of the nozzle δ≈2r_{w}. With a relatively larger frequency, the cost of induction heating equipment is typically relatively higher. Further, with a relatively larger frequency, the electrical efficiency of the power supply is relatively lower. Thus, from an economic standpoint it is beneficial to select an induction frequency around this transition point, because there is little overall advantage to use a higher frequency.

Looking at the problem differently, an optimal nozzle radius and material may be selected, based upon a given induction frequency, to maximize the total thermal power dissipated in the nozzle. In induction heating, approximately 98% of the thermal power is generated within four skin depths from the surface of a susceptor, such as the nozzle. Selecting a nozzle radius approximately equal to four skin depths (r_{w}≈4δ) thus captures the vast majority of the thermal power. For nozzle radii smaller than four skin depths, meaningful current cancellation effects occur and result in less thermal power generation in the nozzle. For nozzle radii exceeding four skin depths, the additional nozzle material does not meaningfully increase the thermal power generated in the nozzle, as compared to a radius of four skin depths. It can be said that the additional material is not being meaningfully volumetrically heated, and so plays little role as an induction susceptor. However, this additional material may serve other purposes, such as helping to dampen temperature transients by providing a larger heat capacity, for example. Thus, nozzles having a radius equal to approximately ten or even fifteen skin depths may perform well in practice.

Here, it has been assumed that the entire nozzle is made up of suscepting material (i.e., the nozzle is the susceptor) and that the radius of the nozzle bore is relatively small with respect to the outside radius of the nozzle. For nozzles where this assumption is not accurate, such as for susceptors having a thin-walled cylindrical geometry, more accurate expressions for power dissipated in the susceptor and the critical frequencies can be derived.

After heat is generated in the extrusion nozzle by induction, heating the nozzle may also involve heat transfer by conduction between different regions of the nozzle. In thermal conduction, heat moves from regions of higher temperature to regions of lower temperature. This heat transfer is governed by Fourier's law of thermal conduction which states:

Q=−k∇T (8).

Here k is the thermal conductivity and T is the temperature of the nozzle material, and ∇ is the gradient operator. The thermal power transferred between two regions increases with thermal conductivity and the temperature gradient between the regions. In induction heating, the skin effect can result in significant thermal gradients within the extrusion nozzle. Since the induced current decreases rapidly with increasing depth from the surface of the susceptor, the majority of the Joule heating occurs close to the surface as well.

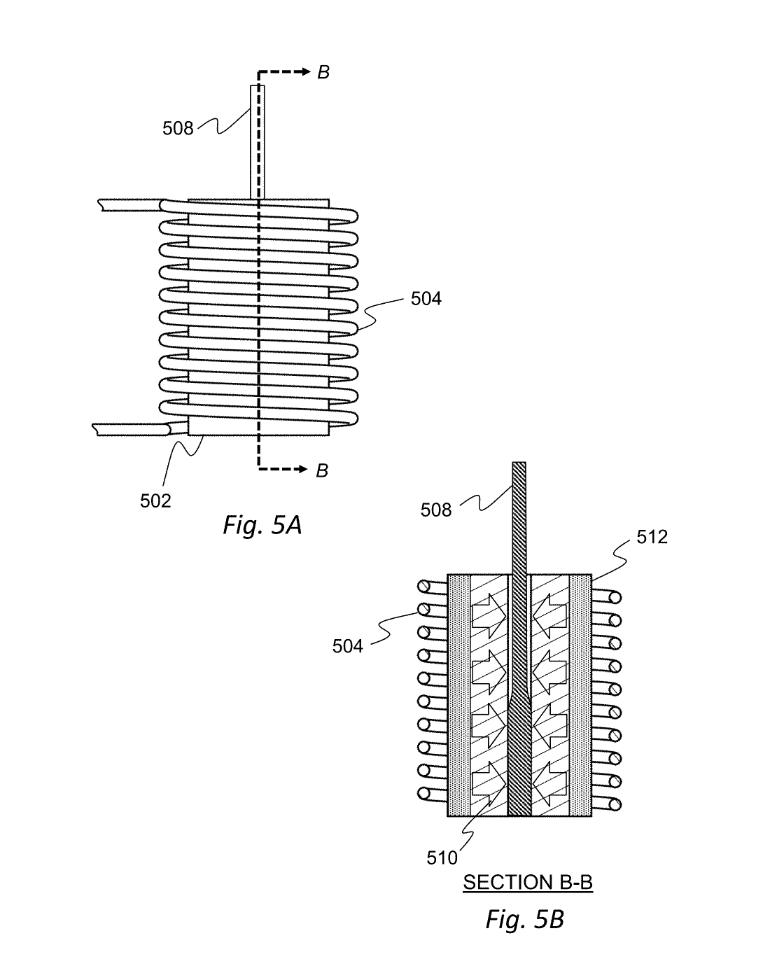

As illustrated schematically in FIG. 5A and the associated cross-sectional view in FIG. 5B, the ultimate goal of heating the extrusion nozzle 502 with an induction coil 504 is to provide the thermal power necessary to heat the build material 508 up to the operating temperature as it passes through the nozzle bore. It is thus necessary to transfer the thermal power generated from the nozzle 502 outer surface 512 (where induction heating primarily takes place) to the internal nozzle bore (where the build material 508 passes through the nozzle). This transfer is indicated by the large, radially inward pointing arrows 510.

From a temperature control standpoint, it is desirable to minimize any time delay introduced by this inward radial heat transfer requirement. To achieve stable extrusion of metal containing multi-phase (MCMP) build material, the thermal system should be able to respond quickly to any variations in thermal load. These variations may, for instance result from changes in the build material feed rate into the nozzle, which are typical upon starting and stopping extrusion. Selecting a nozzle body material with high thermal conductivity k allows the radial transfer of thermal power to occur at a higher rate. If the nozzle body material is also selected to exhibit a low density and specific heat capacity (i.e., a high thermal diffusivity) thermal equilibration can occur even faster because the material's ability to conduct thermal energy is high compared to its ability to store thermal energy.

Generally speaking, a time measure between the generation of thermal power via induction heating and its arrival at the nozzle bore may be referred to as the transport delay for the system. It is thus beneficial to choose the radius r_{w} of the extrusion nozzle to be relatively small so that the distance over which the thermal power needs to be transferred is relatively small. As discussed above, a value of r_{w} close to four skin depths is particularly desirable, because it corresponds to the depth measured from the surface of the nozzle in which 98% of the induction heating occurs. However, a radius less than four skin depths may offer improved dynamic temperature performance, as compared to a larger radius, by lessening the thermal transport delay. However, a radius larger than four skin depths may offer improved temperature stability by increasing the thermal mass of the nozzle, despite the thermal transport penalty.

Based on the efficiency, control and economic criteria discussed above, it is desirable, for a given nozzle material, to select a combination of induction frequency and outer nozzle radius, such that the outer nozzle radius is within a range of one to fifteen skin depths.

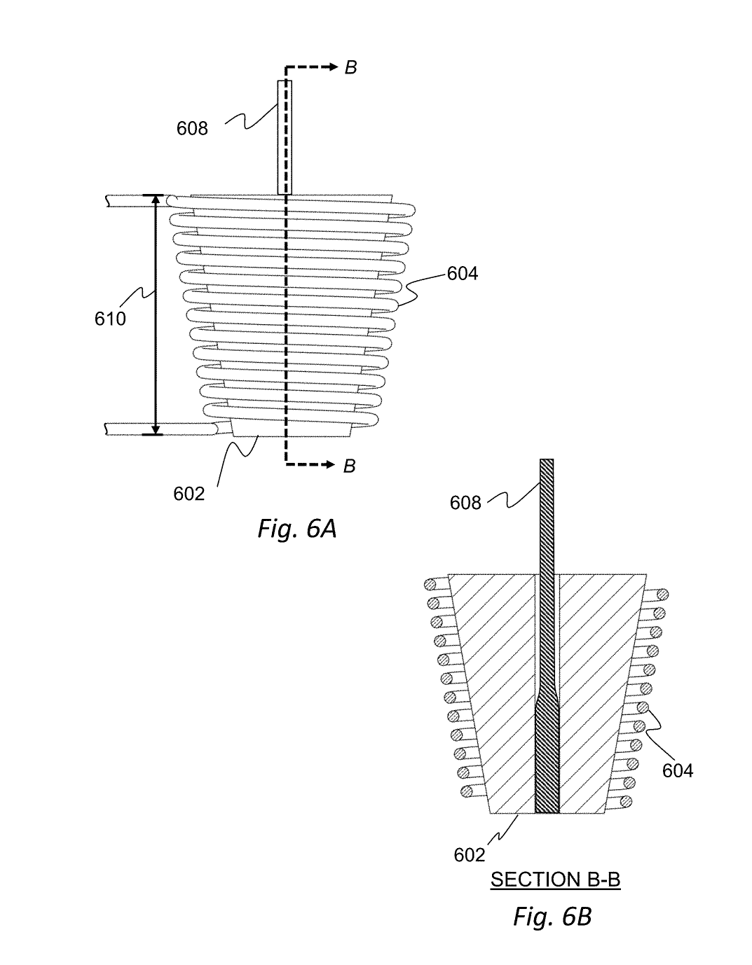

The preceding discussion based on Eq. 7 focused on the specific example of a cylindrical nozzle made entirely of suscepting material and having a bore diameter much smaller than its outer diameter. The conclusions drawn from the specific example are also applicable to more complex nozzle and susceptor configurations. For instance the outer radius of a cylindrical nozzle may change along its axis, such as in a truncated right circular cone (conical frustum). FIG. 6A and the corresponding cross-sectional view in FIG. 6B schematically show a conical extrusion nozzle 602 and a suitable induction coil 604 to heat the nozzle as build material 608 is fed into the nozzle 602. In order to determine a suitable geometry for this conical nozzle at a given induction frequency, the designer should consider an effective radius given by the average outer radius of the nozzle 602 over the length of the portion of the nozzle 610, that is contained inside the induction coil 604. The same guidelines that were previously established for a cylindrical nozzle can be applied to such a conical nozzle, using this effective radius (i.e., average of radii) in place of the simple radius used above. For a conical nozzle a nozzle geometry and frequency combinations should be chosen such that the effective radius is within a range of 1 to 15 skin depths.

Even more complex nozzle and susceptor configurations may include nozzles that do not exhibit the axial symmetry inherent to a cylindrical nozzle, such as for instance nozzles having cross-sections that are rectangular, square, triangular, elliptical or irregularly shaped. Also, the diameter of the nozzle bore may not always be small compared to the outer dimensions of the nozzle. Moreover, instead of the entire nozzle, only a part of the nozzle may act as a susceptor to the induction field. In these cases, it is thus more suitable to again define an effective radius, instead of the simple outer nozzle radius, to determine and specify the desirable dimensions of the nozzle's susceptor. For the more complex nozzle and susceptor configurations described above, it is necessary to generalize the definition of the effective radius used above for the simpler case of a conical nozzle. A general definition of this effective radius may be based on the distance between the outer periphery of the nozzle susceptor and the center line of the nozzle bore. More specifically, the effective radius is measured as the distance from the outer periphery of the nozzle susceptor to the center line of nozzle bore and this quantity is averaged over the volume of the susceptor contained within the axial extents of the induction coil. A combination of induction frequency and susceptor geometry should thus be selected such that the effective radius is within a range of one to fifteen skin depths. It is important to note that this generalized guideline based on the effective radius is not only suitable for the more complex nozzle and susceptor configurations discussed above, but equally applies to the simple conical and cylindrical nozzles discussed herein. It is also understood that by referring to the effective radius of the extrusion nozzle the precise intent is to refer to the effective radius of the nozzle susceptor. This is of particular importance in cases in which the nozzle susceptor only makes up a portion of the extrusion nozzle.

Variable frequency induction power supplies are commercially available and may be used, in which case nozzle performance should be analyzed over the range of frequencies of interest. They may be used to tune the operating frequency towards the optimal frequency as the temperature dependent material properties change, for example.

The induction coil geometries graphically presented herein have been of the conventional singular turn helical variety, however alternative coil geometries are possible. For example, double layer, variable pitch, or variable radial spacing are possible. In general, a coil should be wound to closely match its inner, open space geometry, with the outer, perimeter geometry of the nozzle. Geometry is an important variable in determining the heat pattern in the nozzle.

In the above discussion of a cylindrical nozzle, made entirely of suscepting material and placed inside a long induction coil, it was assumed that the induced current density and dissipated power density are constant along the length of the nozzle. This may not be the most desirable configuration for induction heating an extrusion nozzle for metal FFF, using MCMP build materials. In many cases it may be more desirable to preferentially heat certain sections along the length of the nozzle. Heating certain sections of the nozzle, but not others, facilitates establishing a desirable axial temperature profile.

For instance, it may be beneficial to achieve a temperature profile that exhibits a higher temperature at the nozzle outlet than at the nozzle inlet. More specifically, for MCMP build materials it is desirable to keep the nozzle outlet at the operating temperature while the nozzle inlet is kept below the solidus temperature of the MCMP material. In this way, the build material is solid upon entry, and this solid portion can be used as a plunger, or mechanical pusher for the downstream, multi-phase quantities of build material, while those downstream portions can be in a multi-phase liquid and solid and in-between condition at a higher temperature, suitable for extrusion out from the nozzle outlet. Extruding MCMP from a nozzle that is at a relatively lower temperature, less than the solidus of the build material, at the nozzle inlet, and at a relatively higher temperature within a working temperature range, is discussed in several patent applications that are also owned by and in the name of an Applicant hereof, Desktop Metal, Inc., of Burlington, Mass., USA. U.S. application Ser. No. 16/035,296, filed on Jul. 13, 2018, entitled THERMALLY ROBUST NOZZLE FOR 3-DIMENSIONAL PRINTING AND METHODS OF USING SAME, discusses metal containing, multiphase materials in detail, and nozzles for three dimensionally printing such materials, and temperature profiles for such nozzles, which are relatively cooler at their inlet and relatively warmer at their outlet. The foregoing application is hereby incorporated herein by reference in its entirety.

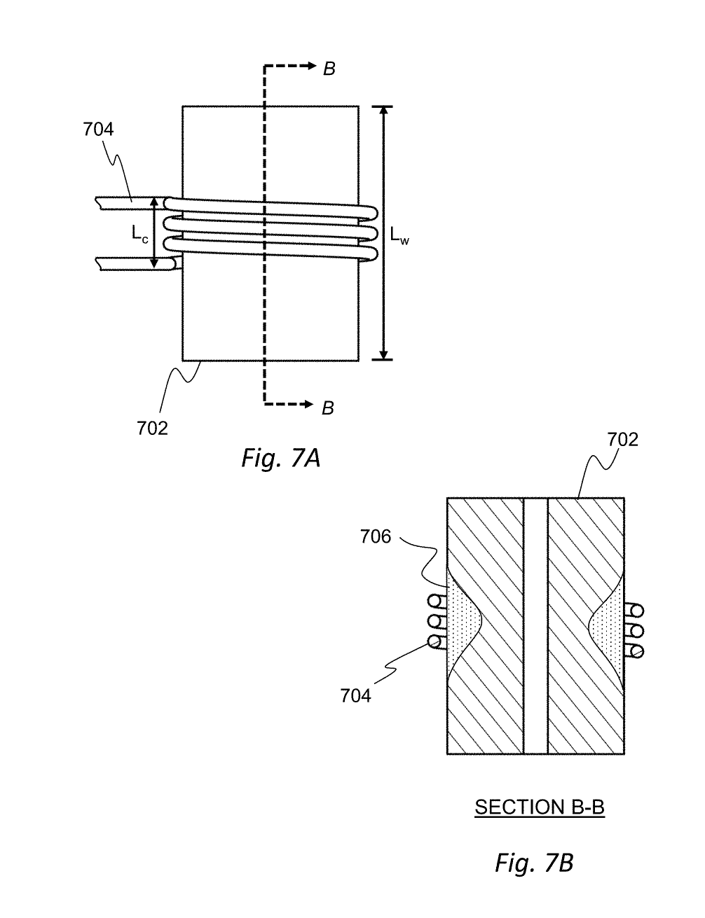

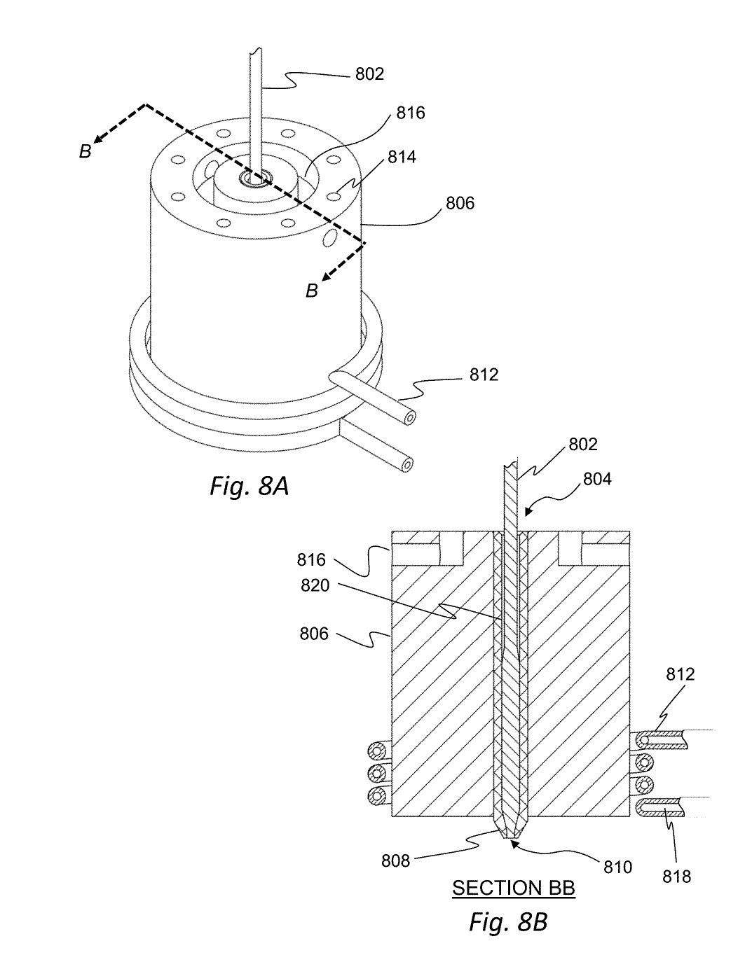

Preferential induction heating of a section of the extrusion nozzle can be achieved by axial localization of the current density induced by the induction coil. As shown schematically in FIG. 7A and the associated cross-sectional view FIG. 7B for a cylindrical nozzle made entirely out of suscepting material, axial localization of the current density may be achieved by using an induction coil 704 with a length L_{c} shorter than the length L_{w} of the extrusion nozzle 702, and preferentially shorter than the length of the nozzle section to be heated. Providing an induction coil having a shorter length than the nozzle, however may not be sufficient to localize the induced current in the desired adjacent section. At either axial end of the induction coil, the induced current density 706 does not abruptly drop to zero, but decays approximately exponentially with axial distance from either end of the induction coil. The majority of the Joule heating resulting from the decaying current density 706 occurs approximately within an axial distance of one skin depth away from each end of the coil. In order to make use of this heating potential, the nozzle should be shorter than the axial length of the coil. It is thus desirable to provide a coil having an axial length that is approximately two skin depths less than the length of the nozzle section to be heated (or one skin depth less, if the section to be heated is located at either end of the nozzle, as shown in FIG. 8A and FIG. 8B). More generally, to preferentially heat a section of the extrusion nozzle, the extrusion nozzle is desirably longer than one skin depth.

More complex temperature profiles along the extrusion nozzle may be achieved by using multiple thermal power sources or sinks along the nozzle and/or by exploiting the temperature gradients that naturally arise from heat transfer by thermal conduction along the nozzle length and losses to the environment through radiation and convection. Multiple separate induction coils may be used, as well as other heat sources, such as resistive heaters, to supplement/assist induction heating or independently heat another section of the nozzle. Heat sinks such as air cooling (described in more detail below) and special configurations of a single induction coil such as those described below may be used to establish relatively complex temperature profiles.

More complex temperature profiles along the nozzle may also be achieved by using more complex induction coil geometries than the conventional single turn helical variety shown here. For instance, properties defining the geometry of the induction coil such as the number of layers of winding, the pitch (i.e., axial distance) between windings and the radial gap between the windings and the outer surface of the nozzle may vary between different induction coils and even along the axes of the same induction coil.

In general, a relatively higher thermal power will be dissipated in sections of the nozzle adjacent to sections of the coil exhibiting a relatively higher winding density (i.e., coil windings per unit axial length of the coil) and a relatively smaller radial gap between the coil and the nozzle. By varying the winding density and the radial gap along the axis of the induction coil it is thus possible to induce more thermal power in one section of the nozzle than in another.

Moreover, some sections of the nozzle or coil may be designed to minimize the thermal power induced in the nozzle. By linking coil sections that provide low induced thermal power with those that provide relatively higher induced thermal power, a single coil may be used to heat multiple sections of the extrusion nozzle. Sections of the coil that provide low induced thermal power may exhibit, for instance a lower winding density and/or a larger gap between the coil and the nozzle, compared to the rest of the coil. The same effect may also be achieved by selectively shielding a section of the extrusion nozzle or induction coil from each other.

For a given induction coil, the induced current density and thus the generated thermal power may also be localized inside the nozzle by changing the geometry of the nozzle susceptor. For instance, if the susceptor only constitutes a part of the nozzle rather than the entire nozzle, the susceptor may be localized in the nozzle section to be preferentially heated.

With reference to FIG. 8A and associated cross-sectional view FIG. 8B, a nozzle for FFF employing an induction heater is presented. The build material 802 enters the nozzle at the inlet 804. The nozzle may be fabricated from multiple pieces, such as the nozzle outer body 806, which interacts with the induction field to provide the majority of Joule heating, and a nozzle inner tube 808, which provides the inner nozzle bore (i.e., fluidic pathway) for the build material. The nozzle inner tube and nozzle outer body are affixed to one another, for instance, via a press fit or other means guaranteeing intimate thermal contact between the components. The susceptor of the nozzle may consist of only the nozzle outer body, or both the nozzle outer body and the inner tube. Because the outer body surrounds the inner tube, in most cases the majority of the thermal power will be induced in the nozzle outer body. An effective radius of a nozzle outer body 806 can be determined based on the general definition described above. The distance from the outer periphery of the nozzle outer body is measured to the center line of nozzle bore and this quantity is then averaged over the volume of the susceptor contained within the axial extents of the induction coil. For a tubular outer body the effective radius is equal to the outer radius of the nozzle outer body. The end of the nozzle inner tube 808 is referred to herein as the outlet 810, where the build material exits and becomes an extrudate or part of a fabricated object (not shown). The induction coil 812 forms one or more windings around the nozzle body and is connected to the induction heating power supply (not shown). The induction coil itself may have an annular cross-section 818, whereby cooling fluid such as water may be flowed by a pump or the like (not shown). The nozzle assembly may be mounted to the remainder of the printer via mounting features 814. The induction coil is shown affixed spatially near the outlet 810 end of the nozzle assembly via an external mounting arrangement (not shown).

The nozzle body 806 may optionally have geometry such as channels for forced cooling 816 near the inlet end. In combination with the volumetric heating created within the nozzle body 806, the cooling channels 816 may be employed to maintain a monotonically increasing temperature profile (or other profiles) from the inlet end of the nozzle to the outlet end of the nozzle. U.S. application Ser. No. 16/035,296, filed on Jul. 13, 2018, entitled THERMALLY ROBUST NOZZLE FOR 3-DIMENSIONAL PRINTING AND METHODS OF USING SAME, mentioned above, discusses apparatus and methods for providing a nozzle that is both heated and cooled simultaneously, to establish a relatively cool temperature near the nozzle inlet, and a relatively hotter temperature near the nozzle outlet, and means to adjust the temperature with fine control. In general, thermal power is both added and removed from a nozzle. The amount removed may be at least as large as half the thermal power required to condition the material to an extrusion temperature. The amount of thermal power added is at least as large as the sum of the amount removed, the amount to condition the material, and losses to the environment. The amount removed may be comparable to, or much larger than the conditioning amount. The larger the ratio of the amount removed and the conditioning amount, the less sensitive will be the nozzle temperature to fluctuations in build material feed rate. Thermal power can be added and removed at spaced apart locations near the outlet and inlet, respectively, or at adjacent locations. Fine temperature control arises, enabling building with multi-phase metal containing materials having a narrow working temperature range. The Ser. No. 16/035,296 application, discussed above, discloses more complex heating and cooling combinations and temperature profiles, achieved with additional cooling ports and heating regions.

One advantage of a multi-part nozzle design is that portions of the nozzle assembly that wear out or are defective, or obsolete, may be replaced. For example, the nozzle tube 808 may be considered a consumable item and may be replaced when worn, while the remainder of the nozzle assembly is reused. In one embodiment, the nozzle tube includes multiple parts. For example, the nozzle tube may be made from two parts: one at the inlet end (providing primarily build material guidance) and one at the outlet end (providing more of the fluid geometry, as well as the nozzle tip and land), whereby one or both parts may be replaced as needed. Or, if it is desired to use a nozzle set up that has been used for one build material with a different build material, it may be advantageous to use a different nozzle inner tube 808 made from a different material, which different material may be better suited to the second, different build material, than was the original nozzle tube material. It may also be advantageous to use a new nozzle inner tube even of the same material as has been previously used, to avoid contaminations for new build material.

The extrusion nozzle should be made from materials with a melting point much higher than the operating point of the MCMP build material passing through the nozzle. Graphite is a suitable choice for a susceptor material and may form the nozzle outer body 806. Commercially available grades of isostatically pressed graphite may have room temperature thermal conductivities above 100 W/mK and may have thermal diffusivities of approximately 5E−5 m²/s. Graphite may be used in normal atmosphere up to approximately 500° C. and in inert atmosphere up to 1800° C., for example. Copper-infiltrated graphite may be employed to improve the thermal conductivity and diffusivity with a moderate decrease in electrical resistivity, all as compared to graphite without copper.

The material for the nozzle inner tube 808 is selected such that the tube is in excellent thermal contact to the nozzle outer body 806 and exhibits a high thermal diffusivity to allow fast transfer of thermal power from the nozzle outer body 806 to the build material 802 passing through the nozzle bore 820. The nozzle inner tube 808 material is also selected such that it does not undergo undesirable chemical or mechanical interactions with the build material. Such undesirable interactions may for instance include chemical dissolution or mechanical abrasion of the nozzle material by the build material. Other undesirable interactions may include the formation of reaction products between the nozzle tube 808 and the build material, where the reaction products exhibit melting temperatures above the operating temperature of the build material (which could form clogs or other flow impediments) or otherwise negatively affect the extrudability or material properties of the build material. For instance, for many aluminum and zinc based MCMP build materials, reasonably pure (with respect to contaminant elements) high-density isostatically pressed synthetic graphite grades may be sufficiently inert and have high wear resistance (for processing the build materials, and in comparison to other grades of graphite) at the temperatures and timescales in question.

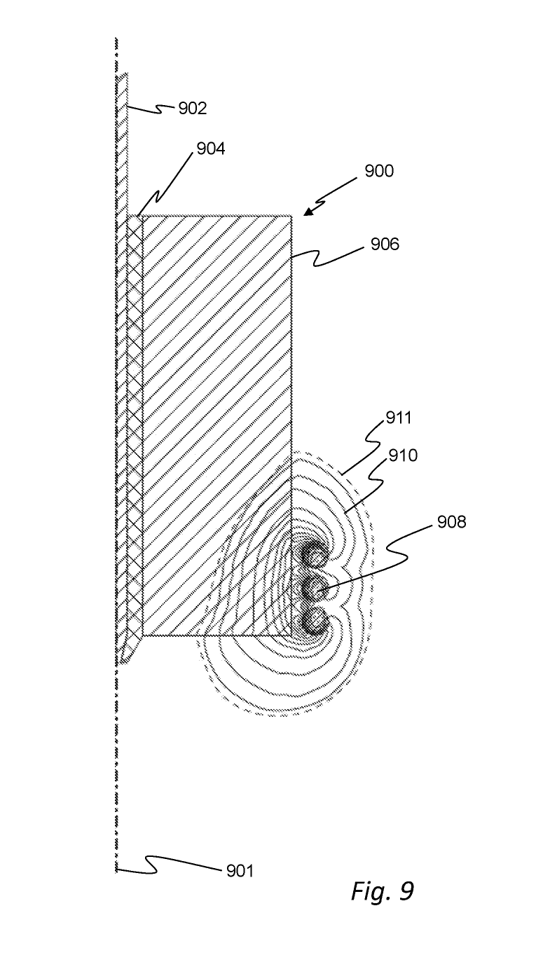

FIG. 9 shows a schematic representation of an axisymmetric numerical simulation of the present teachings hereof, about the line of symmetry 901. The build material 902 enters the nozzle assembly 900, composed of the nozzle inner tube 904 and the nozzle outer body 906. The induction coil 908 is supplied with an alternating electric field from a power supply (not shown). This gives rise to an alternating magnetic field 910, the strength of which is shown schematically in greyscale region, where darker greys indicate stronger fields. A boundary of approximately equal alternating magnetic field strength 911 is denoted by the dotted line, the magnitude of which clearly increases closer to the induction coil 908 (near the center of the surrounded area). The induced current within the nozzle outer body is proportional to the strength of the alternating magnetic field within it. The thermal power density generated as a result of the induced current is proportional to the induced current. Thus, the pattern shown within the extents of the nozzle outer body 906 can also be considered to be proportional to the thermal power density generated inside the nozzle body.

The problem was defined as an axisymmetric time-harmonic magnetics problem, where current in the copper conductors of the induction coil 908 and the induction frequency were defined as fixed quantities at 175 A and 100 kHz, respectively. The boundary approximates an open boundary condition. The materials are as follows: the nozzle inner tube 904 is made from isostatically pressed graphite; the nozzle outer body 906 is made from copper infiltrated graphite; and the build material 902 is 2024 aluminum alloy 1614. Room temperature material properties were used for all materials. It is beneficial if the inner tube is made from wear resistant material, which may be more expensive than less wear resistant material. Thus, it is beneficial that the inner tube be separable and independently replaceable.

As shown schematically with reference to FIG. 9, one important challenge using induction to heat the extrusion nozzle of a metal FFF 3D printer is managing stray fields (i.e., the magnetic field 910 extending outside of the induction coil 908). While the strength of the magnetic field is much lower with increasing distance from the induction coil 908, parts of the printer other than the nozzle, such as the build platform unit, may at times be sufficiently close to the induction coil to interact strongly with any stray field. Such interaction may include undesirable heating of components of the printer other than the nozzle. Such heating may lower the efficiency of the induction heating of the extrusion nozzle.

While these challenges may arise for many components of the 3D printer, they are of particular concern for the build platform unit 318 (FIG. 3), the build material 310 and the object being printed 373. The build material 310 is fed into the nozzle inlet 305 and extruded from the nozzle outlet 316 and may thus be in close proximity to the induction coil 320 that heats the nozzle 302. Similarly, while the object is being printed, the induction coil 320 may be very close to the extruded build material and previously printed layers 392 of the object, particularly the most recently printed 390. Further, while the first few layers 393 of the object are being printed, the surface 319 of the print platform unit 318 may also be in very close proximity to the induction coil 320. (In a typical arrangement, while the object is being fabricated, the build platform unit 318 is moved downward, away from the nozzle outlet 316, or the nozzle outlet is moved upward, away from the build platform unit, or a combination of both occurs.) During operation of the 3D printer, these components of the 3D printing system could thus heat up undesirably or reduce the power dissipated in the extrusion nozzle, unless appropriate remedial steps are taken.

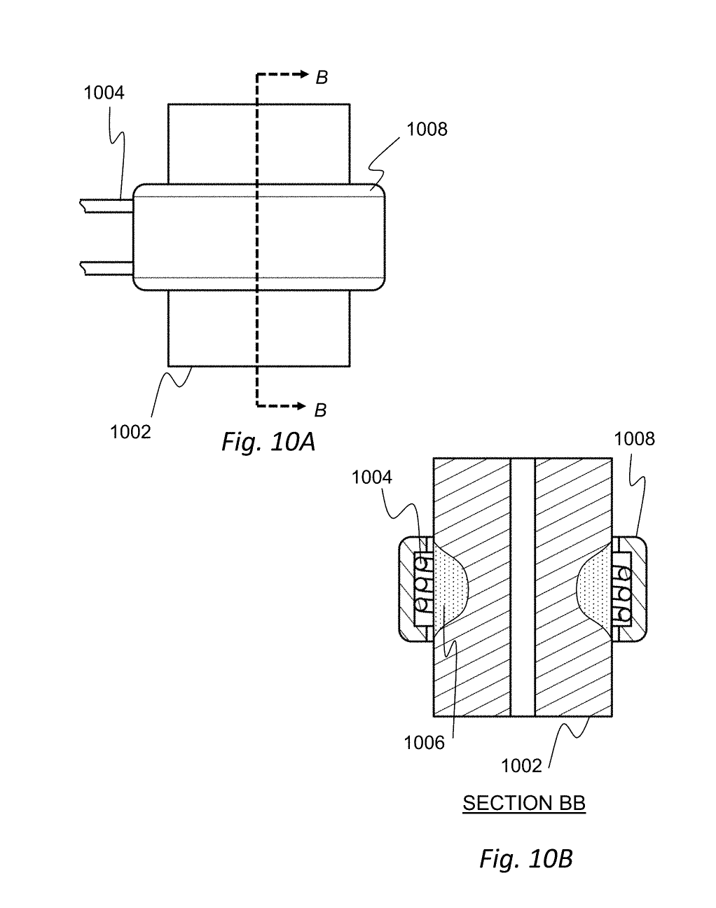

Several strategies may be employed individually or in combination to minimize undesirable interaction between stray fields and the components of the 3D printer. For instance, as shown in FIG. 10A and the associated cross-sectional view in FIG. 10B, a magnetic flux concentrator 1008 may be installed around the induction coil 1004. The flux concentrator 1008 preferentially surrounds the outer boundaries of the induction coil 1004 that are not adjacent to the extrusion nozzle 1002. Outside of the coil, the flux concentrator 1008 provides a channel with low magnetic resistance (reluctance) for the magnetic flux (generated by the induction coil), which guides the flux lines and thus reduces stray fields. In fact, the net lower reluctance may result in lower coil currents for the same induction field strength.

Such a flux concentrator may be made of a high magnetic permeability and low power loss materials such as for example, iron-based materials, nickel-based materials, cobalt based materials, pure ferrites, ferrite-based materials, carbonyl iron-based materials, laminated materials, and magneto-dielectric materials. Useful materials may also include soft magnetic composites made from ferrous particles (iron, cobalt, nickel or their alloys), covered with a thin electrical insulation layer and mixed with organic or inorganic binder.

The flux concentrator may be an open section and surround the exterior boundaries of the induction coil in close proximity. An open section has at least one open side, such as an L or C profile, whereas a closed section has no open sides, such as an O or D profile. Nominally, the nozzle susceptor should close the open sides of the profile. The concentrator 1008 shown in FIG. 10B has a C shaped cross-section. The concentrator is preferably tight to both the coil and the exterior surfaces of the outer nozzle body susceptor, which the coil surrounds. In this way, the magnetic field may be localized to either the nozzle body susceptor or to the concentrator.

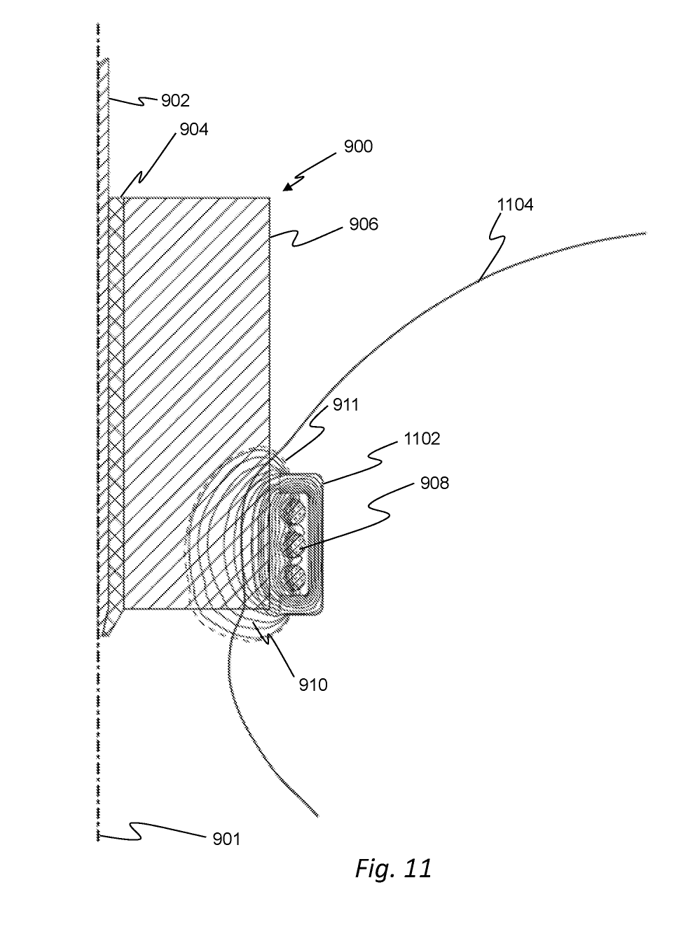

With reference to FIG. 11, an implementation of a flux concentrator 1102 around an induction coil can be seen. FIG. 11 shows a nozzle outer body susceptor 906 and coil 908, as shown in FIG. 9, further provided with a concentrator 1102. The concentrator has a C-shaped open cross-section. Here, the nozzle outer body susceptor 906 closes the open side of the C. As can be seen, the strength of the magnetic field 910 within the susceptor is somewhat more concentrated, as compared to the case presented in FIG. 9 (without the concentrator), and the strength of the field external to the nozzle has been dramatically reduced, with the same comparison. The shape of the flux lines 1104 further support this notion. Here, the use of a build material 902 with lower performance index than the nozzle's performance index and shielding of the build platform unit, as will be discussed below, may not be necessary.

Implementing a flux concentrator may require considerations of the strength of the magnetic fields in which it is present because the concentrator materials have saturation limits. In a field beyond its saturation limit, the flux concentrator may not be able to effectively guide the induction field, resulting in potentially large stray fields. Furthermore, despite their low resistivities, some thermal power will be dissipated in the concentrator itself. Temperature management or cooling of the concentrator may be required due to its maximum operating temperature, proximity to the hot extrusion nozzle and self-heating effects.

In addition to reducing undesirable heating of adjacent regions of the printer, a flux concentrator may also improve the electrical efficiency of the induction coil and aid in localizing the induced current density 1006 (FIG. 10B) and thus induction heating to a specific axial section of the extrusion nozzle.

Another strategy that may be employed to minimize undesirable interaction between stray fields and adjacent components of the 3D printer is to establish a favorable magnetic coupling coefficient between the induction coil and the component in question. Particularly, the magnetic coupling coefficient between the induction coil and the extrusion susceptor of the nozzle should be much larger than the coupling coefficient between the induction coil and other adjacent components of the printer. This strategy is particularly well suited to prevent undesired direct (induced) heating of the build material. Such undesired heating may include, for instance, premature heating of the build material before it enters the extrusion nozzle, as well as overheating (i.e., heating above the operating temperature) of the build material as it is extruded and leaves from the nozzle outlet. (Overheating of the build material is undesirable for several reasons, including, because that it could lead to the build material having an excessive amount of a liquid phase and having a viscosity that is too low for controllable extrusion.)

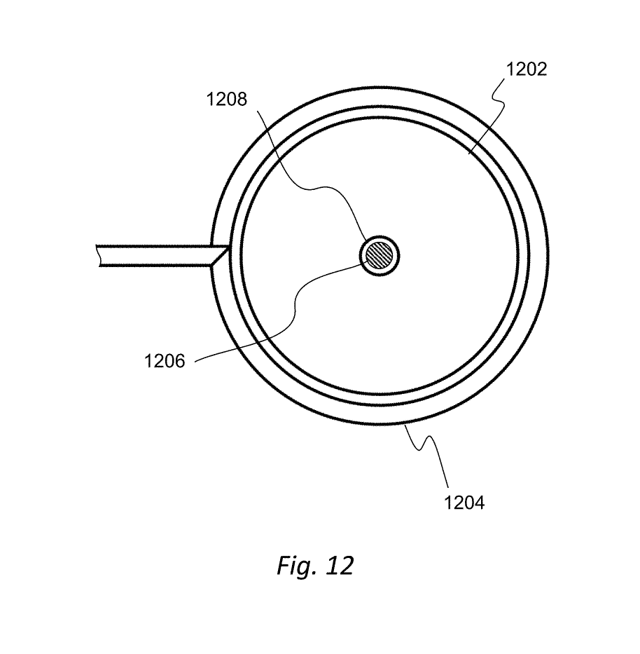

To maximize the coupling coefficient between the nozzle susceptor and the induction coil and minimize the coupling coefficient between the build material and the induction coil, it is beneficial to select the geometry of the nozzle susceptor such that its cross sectional area is as close as possible to the cross sectional area of the induction coil and to select the geometry of the build material such that its cross-sectional area is much smaller than the cross-sectional area of the induction coil. This concept is illustrated in an example in FIG. 12 showing a top view of a cylindrical nozzle 1202 made entirely out of suscepting material. Where the build material 1206 is also supplied in a cylindrical geometry (for example by using wire- or rod-based feedstock material). Here, the diameter of the nozzle 1202 should be selected to be close to the inner diameter of the induction coil 1204 and the diameter of the nozzle bore 1208 should be much smaller than that, such that the diameter of the build material 1206, which needs to fit into the nozzle bore 1208, is much smaller than the inner diameter of the induction coil 1204. More specifically, the inner diameter of the coil should be approximately less than 1.4 times the outer diameter of the nozzle.

According to Eq. 7, at a given induction frequency, the power dissipated in a piece of material depends on its geometry and material properties. The induction heating process can thus be optimized to maximize the power dissipated in the extrusion nozzle and minimize the power dissipated in adjacent components of the printer. This can be achieved by carefully selecting the material properties of the nozzle susceptor material and the build material.

According to Eq. 7, the power dissipated by the alternating magnetic field inside a material is proportional to the previously defined performance index. It is thus desirable to select a nozzle susceptor material and build material such that the nozzle material has a much higher performance index than the build material. In this way, the power dissipated in the nozzle far exceeds the power dissipated in the build material from the induction field. Generally, a ratio of a performance index of the nozzle versus that of the build material of three or preferably five or even more preferably ten or more is desirable.

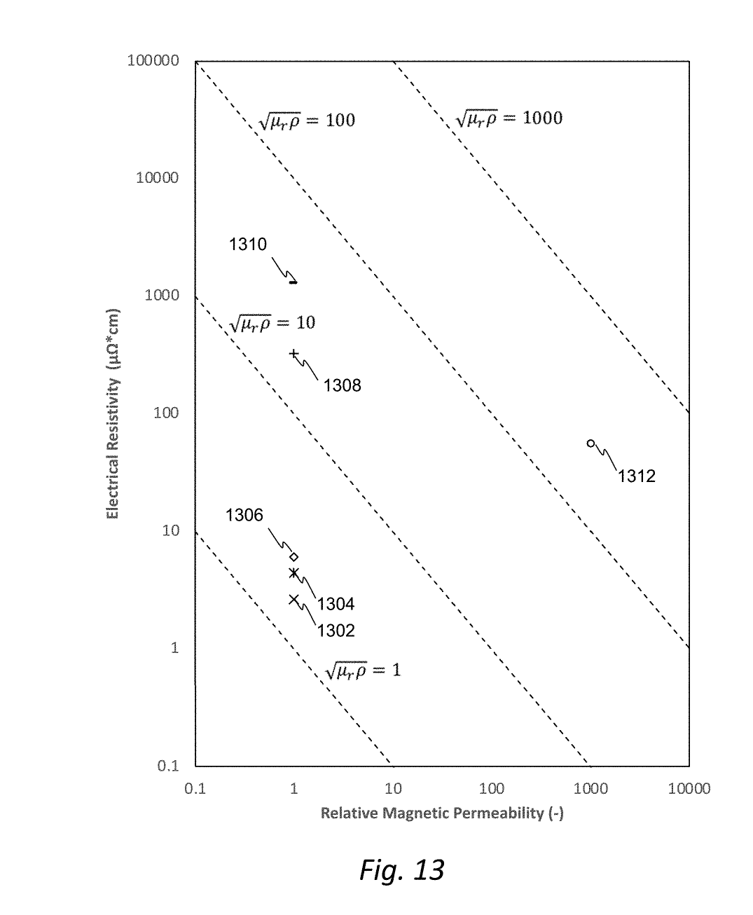

FIG. 13 provides a useful graphical representation of this material selection criterion for materials that have an effective radius larger than their skin depth. It shows a subset of the available parameter space for electrical resistivity and relative magnetic permeability and for reference highlights selected lines of equal performance index. Each of the four diagonally extended (upper left to lower right) dashed lines represents a different line of equal performance index. The plot is presented on log-log axes. The following materials are plotted at the points indicated by the respective reference numerals: aluminum (pure) 1302, A356 aluminum alloy 1304, zinc-aluminum die casting alloy 1306, copper infiltrated graphite 1308, graphite, 1310, AISI 420 stainless steel 1312. (Note that all but the stainless steel 1312 have approximately equal relative magnetic permeability of 1, but different performance indices, due to their different electrical resistivity.) Based on FIG. 13, a nozzle susceptor material and build material combination may be chosen such that the performance index of the nozzle is much higher than the performance index for the build material. For instance, as indicated in FIG. 13, graphite 1308 is a suitable nozzle susceptor material for use when extruding aluminum alloy build materials because the performance index of approximately 18 μΩ^{1/2}·cm^{1/2} for copper infiltrated graphite is much larger than for aluminum alloys, for example A356 1304, having a performance index of approximately 2 μΩ^{1/2}·cm^{1/2}. It can be noted that for many materials typically used in induction heating, as mentioned above, the relative magnetic permeability is approximately one, and thus, for these materials, it may be sufficient to use the square root of electrical resistivity alone as a close-enough stand-in for the performance index and to select a nozzle susceptor material with a much higher electrical resistivity than the build material. The material selection criteria described here are not limited to the build material. They may also be used to appropriately choose the material for other components of the 3D printing system, that may at times come in close proximity with the induction coil, which are discussed below.

As previously mentioned, another potential area of concern would be the coupling of the induction field with the build platform unit.

First, the form and function of various components of the build platform unit will be presented, and then consideration will be given to their interaction with the stray induction field. In an embodiment where a flux concentrator is used, such as shown schematically in FIGS. 10A, 10B and 11, with which any stray induction field is sufficiently small, it may not be necessary to design the components of the build platform unit with consideration for the induction field. However, the primary function of each of the components of the build platform assembly will still be respected.

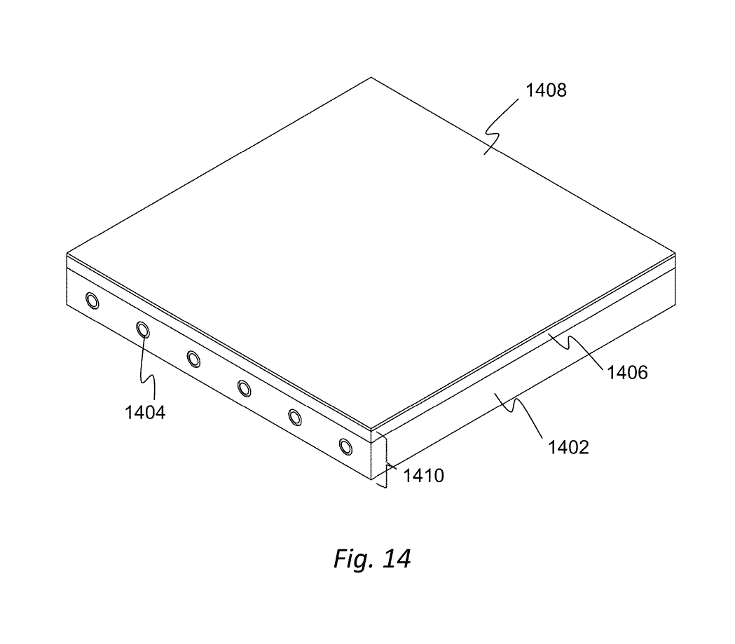

A build platform unit 318 (FIG. 3) supports the object being fabricated 373. The first printer layer 395 must adhere or bond to the upper surface of the build platform unit 319. The build platform unit 318 may include a temperature control system (discussed below in connection with FIG. 14), which may have means of heating, or cooling, or both, temperature sensing and control. The object being fabricated 373 should beneficially bond, adhere, weld, join, or otherwise be retained with some resistance to shear to a surface 319 of build platform unit to react against any forces that may be present during the printing process. These may include forces due to relative acceleration of the build platform unit 318 and the nozzle outlet 316, via the robotics, internal stresses within the object itself imparted by the printing process, or contact between the tip of the deposition nozzle 302 and the object 373. It is desirable for the printed object 373 to be relatively readily removable or separable from the build platform unit 318.

A build platform unit 318 may divide the aforementioned functions amongst multiple different components or materials. With reference to FIG. 14, the build platform unit 1410 may be composed of multiple components. As contemplated herein, a build base 1402 includes or is in contact with optional thermal management (heating and/or cooling) components 1404. The build base 1402 may also provide the majority of the mechanical structure to the build platform unit 1410. A build sheet 1406 (and also shown in FIG. 3 at 317) is temporarily affixed to the build base 1402 during the printing process via mechanical fasteners, clamps, vacuum/suction or other methods known in the art. Optionally, the build sheet 1406 may have an adhesion control layer 1408. The adhesion control layer 1408 is designed to augment or reduce (which are opposite tendencies) or, in general, to control the adhesion between the printed object and the build sheet 1406. In embodiments where there is no build sheet 1406, optionally the build base 1402 may have an adhesion control layer present, rather than a build sheet, which adhesion control layer is similarly designed to augment, reduce or control the adhesion between the printed object and the build base 1402.

Thus, the adhesion control layer is designed to ensure that the extruded build material in the first layer 395 of the fabricated object 373 adheres strongly enough to the build sheet 1406 so that the forming object remains in place and withstands the shear forces discussed above that arise during fabrication. It is also important that the finished fabricated object 373 can be detached from the build sheet 1406 when fabrication is completed. Thus, the adhesion control layer 1408 may play a role in both activities: securing the part to the build platform unit 318 and also allowing its release. Although these roles may be seen as in some way the opposite of each other, it can be understood that an adhesion control layer can facilitate both.

The nozzle typically comes into close proximity with the build platform unit during the print process, especially during the printing of the first several layers 393 of the object 373. (Note that when the first several layers 393 are extruded, the nozzle outlet 316 is at its closest to the surface 319 of the build platform unit 318. At the stage shown in FIG. 3, the distance between the two is somewhat larger, because several layers (six complete, one in progress) have been extruded. If stray induction fields are present, shielding some components of the build platform unit 318 may avoid undesirable excessive self-heating via coupling with the induction field. Not only may the heating of these components be undesirable, but, if the field couples with the build platform unit 318, less thermal power may be dissipated in the nozzle 302, which may be immediately detrimental to the printing process. As has been discussed, it may be desirable to locate the coil axially near the outlet of the nozzle. Therefore, the shielding function may be viewed as most important during the first printed layer 395 or first several layers 393, when the coil 320 would be closest to portions of the build platform unit 318, and, in particular, to the surface 319 that is closest to the coil 320. Careful material selection may reduce the power dissipated into the build platform unit 318, especially while the first few layers 393 of an object 373 are being printed.

For the same reasons as govern the material selection decisions related to build material 310, above, it is thus desirable to select a nozzle susceptor material and material for the components of the build platform unit 318, such that the material of the susceptor of nozzle 302 has a much higher performance index than that of the material of the build platform unit 318. In this way, the power dissipated in the nozzle 302 far exceeds the power dissipated in the build platform unit 318 material. It is further desirable to select the material for the components of the build platform unit 318 such that their performance indices are much lower than that of the nozzle susceptor material.

In one embodiment, if the build base is made from an electrically conductive material, especially one with a performance index similar to or greater than that of the susceptor material of the nozzle, the induction field may strongly couple with the build base. In this case, a build sheet 1406 (FIG. 14) that provides a shielding function may be used.

Turning now to shielding characteristics of the present teachings hereof, there are two primary mechanisms by which objects may be shielded from the magnetic field created by the induction coil: reflection and absorption. Reflection may occur when an electromagnetic wave encounters a new material with different electromagnetic properties to the medium in which the wave had been travelling. Some energy is reflected, and the remainder is transmitted into the new material. The energy that is transmitted may turn into absorptive losses within the new material. Absorption works on the induction heating principles previously discussed.

For common materials, reflection may play an important role in the overall shielding effectiveness at frequencies above approximately 10 kHz and becomes more important at higher frequencies. At lower frequencies, absorption is likely to be the dominant shielding mechanism. The magnetic field may also be guided away from components by using materials with high relative magnetic permeability, up until their saturation.

The effectiveness of a shielding structure may be defined and analyzed in several different ways. Here, adequate shielding pertains to eliminating excessive heating on undesirable components of the printer. The relative importance of each shielding mechanism may be analyzed at the frequency or frequencies of interest.

The coupling between the induction coil 320 and the build base 1402 can be reduced by using a relatively thin build sheet 1406, of material exhibiting a low performance index. For example, sheets of aluminum or copper may be used for the build sheet 1406 due to their low performance index (largely due to their low resistivities). The thickness may preferably be larger than one skin depth of the build sheet material at the operating frequency. For significant absorption, the thickness should be larger than approximately four times the skin depth. Some of the shielding effect may come from reflective losses, and some of the shielding effect may come from absorptive losses within the sheet itself, with one or the other dominating, depending on the materials, geometries and operating frequency. Summarizing, good shielding with minimal self-heating may be obtained when the performance index of the build sheet material is much less than that of the nozzle susceptor, and the skin depth of the build sheet is greater than one skin depth and preferably greater than four skin depths.

The build sheet 1406 may be flexible or easily deformable. When removed from the build base 1402, the build sheet 1406 may elastically or plastically deform by bending it by hand or with the assistance of hand tools. The resulting large curvatures of the build sheet may facilitate removal of the fabricated object (373 FIG. 3). The present teachings hereof include both the material selection and the geometry of the build sheet 1406. Because the bending rigidity scales with a plate thickness to the third power, in a particular embodiment, it is advantageous to select a build sheet that is relatively thin. If, for example, made from 3003-H14 aluminum, preferably, the build sheet thickness can be between approximately 0.25 mm [0.01 in] to 6.35 mm [0.25 in], and most preferably between 0.3-1.27 mm [0.012 in-0.050 in]. At a frequency of 100 kHz, these thicknesses correspond to a range of skin depth of from approximately one to twenty-five skin depths, and preferably between approximately one and four skin depths. With these thicknesses and operating frequency, it is possible to achieve good shielding during the printing process while also providing the desired flexibility to facilitate the removal of the printed object from the build sheet during post-processing.

In another embodiment, the build platform unit 318 is largely constructed from electrically non-conductive materials. When such an embodiment is not possible due to other constraints, the amount of self-heating may be substantially mitigated via the incorporation of a shielding layer into the build platform unit, as discussed above. If an electrically conductive build sheet is still desired, it may be designed to minimize its self-heating due to coupling with the stray field by choosing a performance index much smaller than that of the nozzle susceptor and/or limiting the thickness to less than one and preferably much less than one skin depth in the build sheet material at the operating frequency.

The build sheet 1406 may be in intimate thermal contact with the build base 1402. In this case, any heat generated in the build sheet may be quickly dissipated to the remainder of the already-heated build base structure.

Similar design guidelines as above exist for the adhesion control layer, if present. The adhesion control layer may be made nearly transparent to the magnetic field by making the layer substantially thinner than one skin depth in the material at the operating frequency. A thickness corresponding to 5% of the skin depth or less is considered to be substantially thinner than one skin depth. To prevent overheating or melting of the adhesion control layer, care must be taken to ensure the heat dissipated within each cycle of the alternating magnetic field has time to sufficiently dissipate throughout the build platform unit and that the magnitude of the volumetric power density is not too high. This may be particularly beneficial when the adhesion control layer is desirably made from a material that has a large performance index, in order to fulfill its adhesion function, for example. If the adhesion control layer must be substantially thick (with respect to the skin depth in the layer at the operating frequency), then the adhesion control layer should be made from a material with small performance index in order to minimize the amount of heating. In some cases, the performance index of the build sheet and the adhesion control layer may be very similar, and the structure can be treated as homogenous from an electromagnetic viewpoint.

In one embodiment, the build base 1402 is susceptible to heating at the operating frequency from stray fields from the induction coil. This could be, for example, if the build base is constructed from an electrically conductive material with a skin depth in the material approximately equal to or greater than its thickness. The build platform unit 1410 may be shielded by an electrically conductive build sheet 1406, which is placed between the build base 1402 and the printed object (373 in FIG. 3). The build sheet 1406 should preferably extend beyond the projection of the induction coil 320 onto its surface, at all positions, to ensure shielding. For instance, as shown in FIG. 3, the upper surface 319 of the build platform 318 may be a build sheet 1406, or, if it is not present, then an upper surface of a build base 1402. Further, an optional adhesion control layer 1408 may be present in any of these configurations. As discussed below, typically, the adhesion control layer plays no, or only a small role in any shielding functions. The build sheet may wrap around the sides of the build base to provide additional shielding to the edges of the build base.

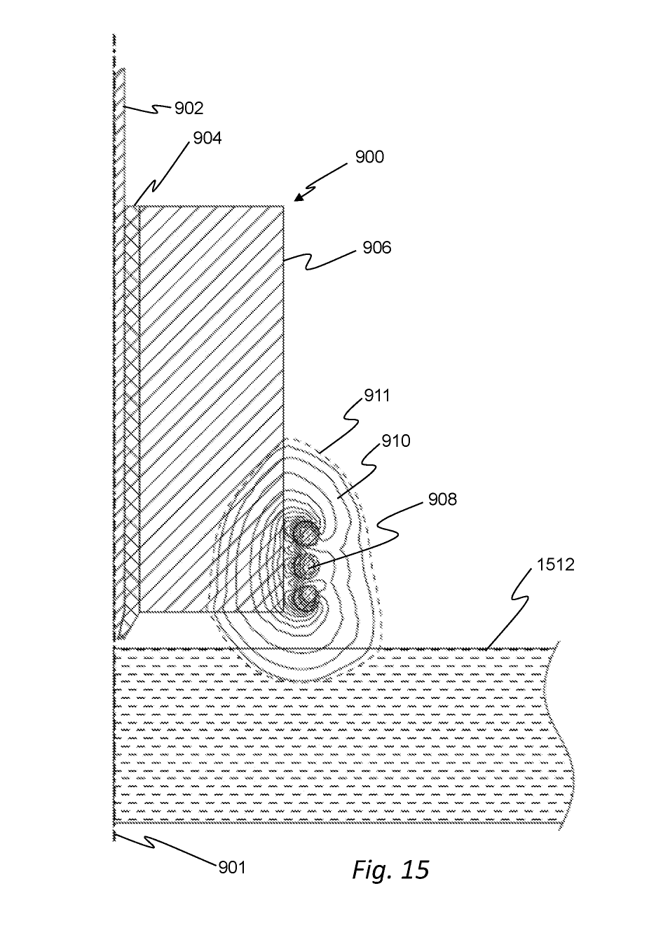

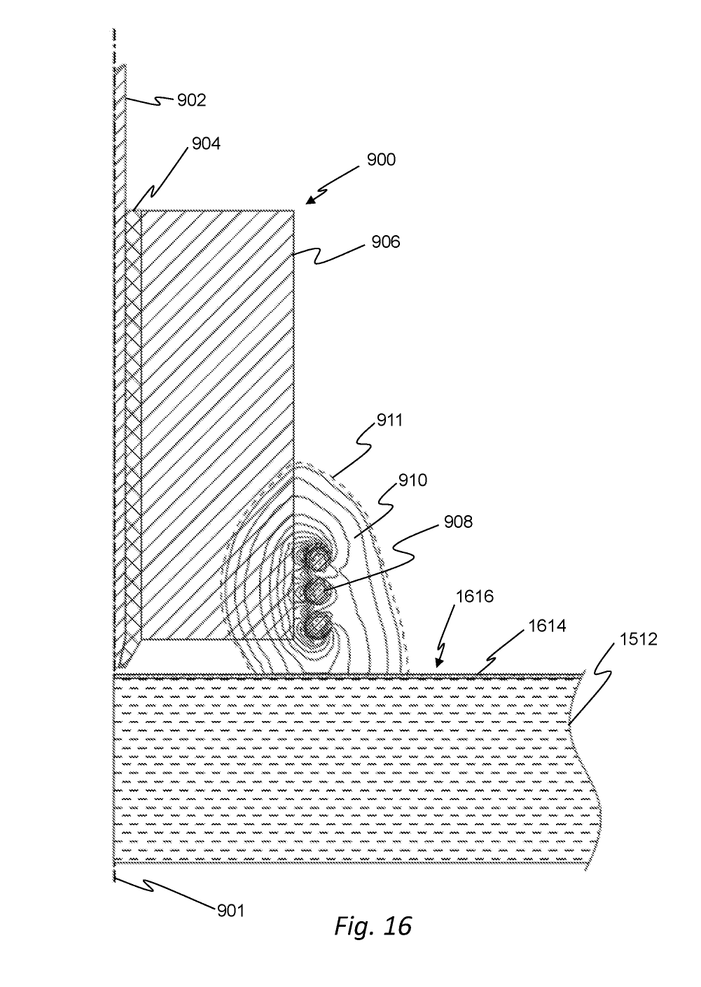

The shielding function of the build sheet 1406 is graphically demonstrated in FIGS. 15 and 16. In FIG. 15 the nozzle with a suscepting outer body is shown in close proximity to the build platform unit comprising a build base 1512. The build base 1512 may be of similar material to the nozzle outer body 906. This illustrates a stage of a printing process just before material is extruded from the nozzle, when the nozzle outlet is located at its closest to the build platform unit. It can be seen that the magnetic field penetrates significantly into the build base 1512 of the build platform unit and therefore would cause induction heating. FIG. 16 shows a solution to this undesirable condition, employing a thin, conductive build sheet 1614 as discussed above, located on top of the build base 1512. Here it can be seen that the alternating magnetic field 910 does not penetrate more than minimally, if at all, into the build base 1512, the build sheet 1614 thereby having shielded the build base 1512 from induction heating.

These simulations follow FIG. 9 and involve the addition of the build sheet 1614, made from 3003 aluminum alloy and the build base 1512 is made from isostatically pressed graphite. As before, room temperature material properties were used for all materials.

In addition to the graphical presentation in FIGS. 15 and 16, numerically computing the expected power loss in each component of the system in FIG. 16, reveals that the build sheet receives 2.9% of the thermal power that the nozzle body receives, and the build base is nearly perfectly shielded, receiving only 0.1% of the thermal power that the nozzle body receives. In FIG. 15 the build base 1512 receives 10.6% in the analyzed case. These results further support the effectiveness of the shielding.

In one embodiment, as shown schematically with reference to FIG. 16, FIG. 3 and FIG. 14 provided herein for illustration purposes, and not to be taken as limiting in any sense, a largely axisymmetric nozzle 900 is created from two primary components: an outer annular susceptor or nozzle outer body 906, and an annular nozzle inner tube 904. The nozzle outer body 906 is constructed from copper infiltrated synthetic isostatically pressed graphite, available under the designation EDM-C3 (manufactured by Poco Graphite Inc., Texas, USA) and the nozzle inner tube 904 is constructed from a high density, high hardness and high thermal conductivity grade of isostatically pressed graphite, available under the designation G540 (manufactured by Tokai Carbon USA, Oregon, USA) The nozzle outer body is 31.75 mm [1.25 in] in outer diameter, 38.1 mm [1.5 in] in length and has an approximately 4.76 mm [0.1875 in] hole in the center to receive the nozzle inner tube, which is affixed via a press fit. The nozzle inner tube has a nominally 4.76 mm (outer) diameter and has a bore for the solid build material at its inlet and a fluidic pathway for extruding the multi-phase build material 902 (i.e., the inlet and the outlet). The outer diameter of the nozzle inner tube 904 is small with respect to the outer diameter of nozzle outer body 906. An induction coil 908 has multiple turns and is tightly fitted to the outside diameter of the nozzle outer body with approximately 2 mm of radial clearance between them. The induction coil is located axially at the extreme outlet end of the nozzle body to assist in achieving a monotonically decreasing temperature profile along the nozzle bore from the nozzle outlet region to the nozzle inlet. The induction coil is driven from an induction power supply (not shown) at approximately 100 kHz (with load and coil present) with variable input power. The skin depth in the nozzle body susceptor is approximately 2.85 mm, or stated otherwise, the 15.875 mm effective radius of the nozzle body susceptor is approximately 5.6 skin depths. At approximately 850 W inputted to the circuit, approximately 500 W of thermal power is generated via Joule heating in the nozzle. The amount of power supplied by the induction power supply is regulated by the controller in response to the sensed temperature of the extrusion nozzle. The build material 902 may be any diameter ranging from approximately 1 mm to 6 mm and be of high electrical conductivity. Possible build materials include: ZA8 and ZA12 zinc-aluminum die casting alloys, aluminum wrought alloys such as 2024 or 6061, or aluminum casting alloys such as A356.

A build platform unit 1616 includes a build base 1512 that can also be constructed of G540 graphite. It contains resistive heating elements (not shown in FIG. 16, but shown in FIG. 14), and would strongly couple with an induction coil when the nozzle is printing the first layer or several of an object due to its graphite construction (for the first layer, corresponding to an axial spacing of approximately 3 mm between the bottom of the lowest coil conductor and the uppermost surface of the build platform unit). A build sheet 1614 is affixed to the uppermost surface of the build base 1512 via a vacuum chuck built into the build base. The build sheet 1614 is a 0.016 in thick sheet of 3003-H14 aluminum. Here, the approximate performance indices, given in μΩ^{1/2}·cm^{1/2} units of the aforementioned system components are as follows: nozzle body susceptor 18.0, build material 2.7, build sheet 1.9, and build base 38.7. Clearly, there is the potential of the build base to be meaningfully heated via the induction coil if no mitigating steps are taken. Therefore, the build sheet takes on a shielding function and substantially shields the build base 1612 from the electromagnetic field 910 from the induction coil 908. Under steady-state conditions, the power required to maintain the nozzle temperature changes only moderately when comparing the case where the nozzle 900 is far away axially from the build platform unit 1616 versus when it is the closest. Therefore, the shielding function of the build sheet 1614 is successful at preventing the magnetic field from reaching the graphite build base 1612.

In another embodiment, the inner nozzle tube can be fabricated from a ceramic, such as aluminum oxide, aluminum nitride, SiAlON ceramics, silicon carbide, or boron nitride.

In another embodiment, the nozzle outer body includes a susceptor that is made from a magnetic material with a Curie temperature above the operating temperature. For example, the nozzle outer body may be made from nickel alloy, such as Kovar. Beneficially, the coefficient of thermal expansion of Kovar remains relatively constant around 5 μstrain/° C., making it well suited to press fitting or joining it with a variety of grades of graphite and types of ceramics due to their similar coefficients of thermal expansion throughout the temperature range from room temperature up to operating temperature. Alternatively, the nozzle outer body can be made from a magnetic grade of stainless steel. Using a magnetic susceptor may enable a much lower operating frequency, as compared to a similarly dimensioned system using a non-magnetic susceptor. As discussed, lower frequency power supplies may offer economic and electrical efficiency benefits. There is also the added benefit of additional heating from hysteresis losses.

All documents mentioned herein are incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term or should generally be understood to mean and/or and so forth.

Recitation of ranges of values herein are not intended to be limiting, referring instead individually to any and all values falling within the range, unless otherwise indicated herein, and each separate value within such a range is incorporated into the specification as if it were individually recited herein. The words about, approximately, substantially, or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (e.g., such as, or the like) provided herein, is intended merely to better illuminate the embodiments and does not pose a limitation on the scope of the embodiments or the claims. No language in the specification should be construed as indicating any unclaimed element as essential to the practice of the claimed embodiments.

In the foregoing description, it is understood that terms such as first, second, top, bottom, up, down, and the like, are words of convenience and are not to be construed as limiting terms unless specifically stated to the contrary.

Regarding metal build materials more specifically, this description emphasizes three-dimensional printers that deposit metal, metal alloys, or other metallic compositions for forming a three-dimensional object using fused filament fabrication or similar techniques. In these techniques, a segment of material is extruded in a layered series of two-dimensional patterns to form a three-dimensional object from a digital model. The segments may also be referred to as roads, beads or paths or lines. However, it will be understood that other additive manufacturing techniques and other build materials may also or instead be used with many of the techniques contemplated herein. Such techniques may benefit from the systems and methods described below, and all such printing technologies are intended to fall within the scope of this disclosure, and within the scope of terms such as printer, three-dimensional printer, fabrication system, additive manufacturing system, and so forth, unless a more specific meaning is explicitly provided or otherwise clear from the context. Further, if no type of printer is stated in a particular context, then it should be understood that any and all such printers are intended to be included, such as where a particular material, support structure, article of manufacture, or method is described without reference to a particular type of three-dimensional printing process.

The term extrudate refers to the build material that is exiting a nozzle, e.g., in a three-dimensional printing process. The verb to condition is used to mean the act of bringing a build material up to a temperature within its working range, where it has rheological behavior suitable for the printing process.

It will be appreciated that the foregoing techniques may be employed alone or in any suitable combination, and may be combined with other time varying extrusion feed rate regimes such as sinusoidal regimes, ramps, and so forth, provided that the aggregate rate profile supports extended clog-free extrusion as contemplated herein.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the present teachings as defined by the appended claims, which are to be interpreted in the broadest sense allowable by law.

Aspects of the Present Teachings

The following aspects of the present teachings hereof are intended to be described herein, and this section is to ensure that they are mentioned. They are named aspects, and although they appear similar to claims, they are not claims. However, at some point in the future, the applicants reserve the right to claim any and all of these aspects in this and any related applications.

A1. A method of heating a fused filament fabrication extrusion nozzle that is constructed from a nozzle material, and has a length L and an effective radius r, the method comprising, operating an induction coil at an induction frequency f chosen such that the nozzle has an induction skin depth s at the induction frequency f such that:

a. the nozzle induction skin depth s is less than the effective radius r; and

b. the nozzle induction skin depth s is larger than 1/15 of the effective radius r.

A2. The method of aspect 1, further where the nozzle induction skin depth is less than the nozzle length L.

A3. The method of aspect 1, the nozzle comprising:

a. an annular outer body having an outer body outer effective radius equal to the effective radius r; and

b. an inner tube.

A4. The method of aspect 1, wherein the nozzle induction skin depth s is larger than ¼ of the effective radius r.

A5. The method of aspect 1, the nozzle comprising a nozzle material comprising graphite.

A6. The method of aspect 5, the graphite comprising copper infiltrated graphite.

A7. The method of aspect 4, the annular outer body comprising a material suitable as a susceptor for induction heating

A8. The method of aspect 5, further comprising providing a metal containing multi-phase build material into the nozzle.

A9. The method of aspect 5, further comprising providing an aluminum alloy build material into the nozzle.

A10. The method of aspect 3, the inner tube comprising a component that is separable from the nozzle outer body.

A11. The method of aspect 3, the inner tube comprising a material that, is more wear resistant than is the annular outer body.

A12. The method of aspect 1 further comprising the step of providing the induction coil substantially surrounding the nozzle, the coil having an axial extent that is less than the nozzle length L.

A13. The method of aspect 12, the nozzle having an inlet and an outlet, the coil being located along the nozzle at a location that is closer to the nozzle outlet than it is to the nozzle inlet.

A14. The method of aspect 1, further comprising the step of providing a metal containing multi phase (MCMP) build material into the nozzle, the nozzle comprising a nozzle material that has a higher performance index than that of the build material.

A15. The method of aspect 14, further comprising the step of extruding the build material from the nozzle onto a build sheet, the nozzle comprising a material that has a higher performance index than that of the build sheet material.

A16. The method of aspect 15, further wherein the build sheet is a component of a build platform unit that also comprises a build base, to which the build sheet is coupled, further wherein the build sheet:

a. has a build sheet induction skin depth at the induction frequency f;

b. is detachably attached to the build base;

c. has a thickness that is larger than the build sheet induction skin depth; and

d. is located closer to the induction coil than is the build base.

A17. The method of aspects 14, the build material comprising an aluminum alloy.

A18. The method of aspect 16, further wherein an adhesion control layer is located closer to the induction coil than is the build sheet, wherein the adhesion control layer has a thickness, a skin depth at the induction frequency f, performance index, such that either:

a. the adhesion control layer thickness is less than skin depth at the induction frequency f;

or, if the adhesion control layer thickness is larger than skin depth at the induction frequency f; then

b. the adhesion control layer performance index is less than that of the nozzle.

A19. A fused filament fabrication extrusion nozzle for use with an induction heating coil, which nozzle has a length L and an effective radius r, the nozzle comprising a material, such that, when the induction coil is driven at an induction frequency f, the nozzle has an induction skin depth s such that:

a. the nozzle induction skin depth s is less than the effective radius r; and

b. the nozzle induction skin depth s is larger than 1/15 of the effective radius r.

A20. The nozzle of aspect 19, further wherein the nozzle induction skin depth is less than the nozzle length L.

A21. The nozzle of aspect 19, the nozzle further comprising:

a. an annular outer body having an outer body effective radius equal to the effective radius r; and

b. an inner tube.

A22. The nozzle of aspect 19, wherein the nozzle induction skin depth s is larger than ¼ of the effective radius r.

A23. The nozzle of aspect 19, the nozzle material comprising graphite.

A24. The nozzle of aspect 23, the graphite comprising copper infiltrated graphite.

A25. The nozzle of aspect 19, the nozzle comprising

a. a body, comprising a plurality of annular portions;

b. at least one of the annular portions comprising a bore, and being a first grade of graphite; and

c. at least one of the annular portions comprising a second, different grade of graphite.

A26. The extrusion nozzle of aspect 25, the annular portion comprising the bore comprising an inner tube.

A27. The extrusion nozzle of aspect 26, the inner tube being arranged within an inner space of an at least partially surrounding outer annular portion, the inner tube being detachable from the at least partially surrounding outer annular portion.

A28. The extrusion nozzle of aspect 27, the inner tube comprising a material that is more wear resistant than the material of the outer annular portion.

A29. The method of aspect 23, the nozzle comprising a fused filament fabrication nozzle for use with a build material comprising an aluminum alloy.

A30. The nozzle of aspect 21, the inner tube comprising a component that is separable from the annular outer body.

A31. The nozzle of aspect 19, further comprising an induction heating coil.

A32. The nozzle of aspect 19, further for use with a MCMP build material, the nozzle comprising a nozzle material that has a higher performance index than that of the build material.

A33. The nozzle of aspect 19, further for use depositing build material onto a build sheet, the nozzle comprising a material that has a higher performance index than that of the build sheet material.

A34. The nozzle of aspect 19, further comprising an induction coil, having an inner radius, the inner radius of the induction coil being no greater than 1.4 times the nozzle body effective radius.

A35. The nozzle of aspect 34, the induction coil having an axial extent that is less than the nozzle length L.

A36. The nozzle of aspect 35, the induction coil being located closer to the nozzle outlet than to the nozzle inlet.

A37. A printing assembly comprising:

a. a nozzle, having a length L and an effective radius r, the nozzle comprising a material;

b. an induction heating coil, the coil being operable at an induction frequency f, such that, due to the nozzle material, at the induction frequency f, the nozzle has an induction skin depth s such that:

i. the nozzle induction skin depth s is less than the effective radius r; and

ii. the nozzle induction skin depth s is larger than 1/15 of the effective radius r.

A38. The printing assembly of aspect 37, further wherein the nozzle induction skin depth is less than the nozzle length L.

A39. The printing assembly of aspect 37, the nozzle further comprising:

a. an annular outer body having an inner radius and a thickness, and an outer body outer effective radius equal to the effective radius r; and

b. an inner tube.

A40. The printing assembly of aspect 37, wherein the nozzle induction skin depth s is larger than ¼ of the effective radius r.

A41. The printing assembly of aspect 37, the nozzle material comprising graphite.

A42. The printing assembly of aspect 41, the graphite comprising copper infiltrated graphite.

A43. The printing assembly of aspect 39, the inner tube comprising a component that is separable from the annular outer body.

A44. The printing assembly of aspect 37, the nozzle comprising

a. a body, comprising a plurality of annular portions;

b. at least one of the annular portions comprising a bore, and being a first grade of graphite; and

c. at least one of the annular portions comprising a second, different grade of graphite.

A45. The printing assembly of aspect 39, the inner tube comprising a material that, is more wear resistant than is the material of the annular outer body.

A46. The printing assembly of aspect 37, further wherein the induction coil has an inner radius that is no greater than 1.4 times the effective radius of the nozzle body.

A47. The printing assembly of aspect 37, the induction coil having an axial extent that is less than L.

A48. The printing assembly of aspect 47, the induction coil being located closer to the nozzle outlet than it is to the nozzle inlet.

A49. The printing assembly of aspect 37, further for use extruding a MCMP build material through the nozzle, the nozzle comprising a nozzle material that has a higher performance index than that of the build material.

A50. The printing assembly of aspect 37, further comprising a build sheet, the nozzle comprising a material that has a higher performance index than that of the build sheet material.

A51. The printing assembly of aspect 37, further comprising, near the nozzle, a build platform unit comprising:

a. a build base; and

b. a build sheet, that:

i. has a build sheet performance index;

ii. has a build sheet induction skin depth at the induction frequency f;

iii. is detachably attached to the build base;

iv. has a thickness that is larger than the build sheet induction skin depth; and

v. is located closer to the induction coil than is the build base.

A52. The printing assembly of aspect 50, further comprising an adhesion control layer located closer to the induction coil than is the build sheet, wherein the adhesion control layer has a thickness, a skin depth at the induction frequency f, performance index, such that either:

a. the adhesion control layer thickness is less than skin depth at the induction frequency f;

and, if the adhesion control layer thickness is larger than skin depth at the induction frequency f; then

b. the adhesion control layer performance index is less than that of the nozzle.

A53. A nozzle for extruding a metal containing multi-phase (MCMP) build material, the nozzle being heated by induction heating established, by an induction coil, the nozzle comprising a nozzle material that has a higher performance index than that of the build material.

A54. A nozzle for extruding a metal containing multi-phase (MCMP) build material onto a build sheet, the nozzle being heated by induction heating established, by an induction coil, the build sheet comprising a build sheet material, the nozzle comprising a material that has a higher performance index than that of the build sheet material.

A55. The nozzle of any one of aspects 53 and 54, the nozzle material comprising a susceptor material.

A56. The nozzle of any one of aspects 53 and 54, the nozzle comprising an outer body comprising a susceptor material having a performance index that is greater than that of the build material.

A57. A method for extruding, onto a build sheet, a metal containing multi-phase (MCMP) build material from a nozzle, the method comprising:

a. providing a build sheet comprising a build sheet material;

b. providing a MCMP build material;

c. providing a nozzle having a body with a bore there-through, arranged with an inlet and an outlet, the outlet near to the build sheet, the nozzle body comprising a nozzle material, the materials having properties such that the nozzle material has a greater performance index than that of the build material; and

d. extruding the build material from the nozzle onto the build sheet.

A58. A method for extruding, onto a build sheet, a metal containing multi-phase (MCMP) build material from a nozzle, the method comprising:

a. providing a build sheet comprising a build sheet material;

b. providing a MCMP build material;

c. providing a nozzle having a body with a bore there-through, arranged with an inlet and an outlet, the outlet near to the build sheet, the nozzle body comprising a nozzle material, the materials having properties such that the nozzle material has a greater performance index than that of the build sheet material; and

d. extruding the build material from the nozzle onto the build sheet.

A59. The method of any one of aspects 57 and 58, the nozzle material comprising a susceptor material.

A60. The method of aspect 56, the materials having properties such that the nozzle material has a greater performance index than that of the build sheet material.

A61. The method of any one of aspects 57 and 58 and 60, the nozzle comprising an outer body comprising a susceptor material having a performance index that is greater than that of the build sheet material.

A62. The method of any one of aspects 57 and 58 and 60, the nozzle comprising an outer body comprising a susceptor material having a performance index that is greater than that of the build material.

A63. The method of any one of aspects 57 and 58, further comprising, an adhesion control layer located between the build sheet and the nozzle body, the adhesion control layer comprising a material that has a lower performance index than that of the nozzle body material.

A64. A printing assembly for extruding a metal containing multi-phase (MCMP) build material, the assembly comprising:

a. an induction coil; and

b. a nozzle, comprising a nozzle material that has a greater performance index than that of the build material.

A65. A printing assembly for extruding a metal containing multi-phase (MCMP) build material, the assembly comprising:

a. an induction coil;

b. a build sheet, comprising a build sheet material; and

c. a nozzle, comprising a nozzle material that has a greater performance index than that of the build sheet material.

A66. The printing assembly of aspect 64 the nozzle comprising an outer body susceptor and at least one additional component, the nozzle outer body susceptor comprising a susceptor material that has a greater performance index than that of the build material.

A67. The printing assembly of aspect 65, the nozzle comprising an outer body susceptor and at least one additional component, the nozzle outer body susceptor comprising a susceptor material that has a greater performance index than that of the build sheet material.

A68. The printing assembly of any one of aspects 66 and 67, the at least one additional component comprising a separable inner tube.

A69. The printing assembly of any one of aspects 64-683, the induction coil being arranged around the nozzle outer body further comprising a magnetic flux controller. that substantially surrounds the induction coil.

A70. The printing assembly of aspect 69, the magnetic flux controller comprising a perimeter portion, having an open section.

A71. The printing assembly of aspect 65, the nozzle and the coil having an axisymmetric cross-sections.

A72. The printing assembly of aspect 65, the nozzle having a non-axisymmetric cross-section.

A73. A build platform unit upon which an object is to be built from metal containing multi-phase (MCMP) build material that is deposited on the build platform unit, from an extrusion nozzle, which nozzle is constructed from nozzle material having a performance index and can be heated by an induction coil driven at an induction frequency f, the build platform unit comprising:

a. a build base; and

b. a build sheet, that:

i. has a build sheet performance index;

ii. has a build sheet induction skin depth s at the induction frequency f;

iii. has a thickness that is larger than the build sheet induction skin depth s; and

iv. is located closer to the induction coil than is the build base.

A74. The build platform unit of aspect 73, further comprising an adhesion control layer located closer to the induction coil than is the build sheet, the adhesion control layer having a thickness, a skin depth at the induction frequency f, performance index, such that either:

a. the adhesion control layer thickness is less than skin depth at the induction frequency f;

or, if the adhesion control layer thickness is larger than skin depth at the induction frequency f; then

g. the adhesion control layer performance index is less than that of the nozzle material.

A76. A method of heating an extrusion nozzle near to a build platform unit upon which an object is to be built from metal containing, multi-phase (MCMP) build material that is deposited on the build platform unit, from the extrusion nozzle, which nozzle is constructed from a nozzle material having a performance index, the method comprising:

a. inducing heat in the nozzle by operating the induction coil at an induction frequency f;

b. providing, near the nozzle, a build platform unit comprising:

i. a build base; and

ii. a build sheet, that:

A. has a build sheet performance index;

B. has a build sheet induction skin depth at the induction frequency f;

C. is detachably attached to the build base;

D. has a thickness that is larger than the build sheet induction skin depth; and

E. is located closer to the induction coil than is the build base.

A77. The method of aspect 76, the build sheet having a thickness that is larger than twice the build sheet induction skin depth.

A78. The method of aspect 76, the build sheet having a thickness that is approximately equal to three times the build sheet induction skin depth.

A79. The method of aspect 76, the build sheet material having a performance index that is less than that of the nozzle material.

A80. The method of aspect 76, the build platform unit further comprising an adhesion control layer, that is located closer to the induction coil than is the build sheet, the adhesion control layer having a thickness, a skin depth at the induction frequency f, performance index, such that either:

a. the adhesion control layer thickness is less than skin depth at the induction frequency f;

or, if the adhesion control layer thickness is larger than skin depth at the induction frequency f; then

b. the adhesion control layer performance index is less than that of the nozzle material.

A81. An extrusion nozzle, having an inlet and an outlet and a bore there-between, the nozzle comprising:

a. a body, comprising a plurality of annular portions;

b. at least one of the annular portions comprising the bore, and being a first grade of graphite; and

c. at least one of the annular portions comprising a second, different grade of graphite.

A82. The extrusion nozzle of aspect 81, the annular portion comprising the bore comprising an inner tube.

A83. The extrusion nozzle of aspect 82, the inner tube being arranged within an inner space of a partially surrounding outer annular portion, the inner tube comprising a component that is detachable from the partially surrounding outer annular portion.

A84. The extrusion nozzle of aspect 83, the inner tube comprising a material that is more wear resistant than the material of the outer annular portion.

A85. The extrusion nozzle of aspect 81, the annular portion comprising copper infused graphite.

1. A method of heating a fused filament fabrication extrusion nozzle that is constructed from a nozzle material, and has a length L and an effective radius r, the method comprising operating an induction coil at an induction frequency f chosen such that the nozzle has an induction skin depth s at the induction frequency f such that:
a. the nozzle induction skin depth s is less than the effective radius r; and
b. the nozzle induction skin depth s is larger than 1/15 of the effective radius r.

2. The method of claim 1, wherein the nozzle induction skin depth is less than the nozzle length L.

3. The method of claim 1, the nozzle comprising:
a. an annular outer body having an outer body outer effective radius equal to the effective radius r; and
b. an inner tube.

4. The method of claim 1, the nozzle comprising a nozzle material comprising graphite.

5. The method of claim 4, further comprising providing a metal containing multi-phase build material into the nozzle.

6. The method of claim 1, further comprising providing the induction coil substantially surrounding the nozzle, the coil having an axial extent that is less than the nozzle length L.

7. The method of claim 1, further comprising providing a metal containing multi phase (MCMP) build material into the nozzle, the nozzle comprising a nozzle material that has a higher performance index than that of the build material.

8. A fused filament fabrication extrusion nozzle for use with an induction heating coil, which nozzle has a length L and an effective radius r, the nozzle comprising a material, such that, when the induction coil is driven at an induction frequency f, the nozzle has an induction skin depth s that:
a. is less than the effective radius r; and
b. is larger than 1/15 of the effective radius r.

9. The nozzle of claim 8, wherein the nozzle induction skin depth is less than the nozzle length L.

10. The nozzle of claim 8, wherein the nozzle material comprises graphite.

11. The nozzle of claim 8, further comprising an induction heating coil.

12. The nozzle of claim 8, further comprising an induction coil having an inner radius, the inner radius of the induction coil being no greater than 1.4 times the nozzle body effective radius.

13. The nozzle of claim 12, wherein the induction coil has an axial extent that is less than the nozzle length L.

14. A printing assembly comprising:
a. a nozzle, having a length L and an effective radius r, the nozzle comprising a material; and
b. an induction heating coil, the coil being operable at an induction frequency f, such that, due to the nozzle material, at the induction frequency f, the nozzle has an induction skin depth s such that:
i. the nozzle induction skin depth s is less than the effective radius r; and
ii. the nozzle induction skin depth s is larger than 1/15 of the effective radius r.

15. The printing assembly of claim 14, wherein the nozzle induction skin depth is less than the nozzle length L.

16. The printing assembly of claim 14, the nozzle further comprising:
a. an annular outer body having an inner radius and a thickness, and an outer body outer effective radius equal to the effective radius r; and
b. an inner tube.

17. The printing assembly of claim 16, wherein the inner tube comprises a component that is separable from the annular outer body.

18. The printing assembly of claim 14, the nozzle comprising:
a. a body, comprising a plurality of annular portions;
b. at least one of the annular portions comprising a bore, and being a first grade of graphite; and
c. at least one of the annular portions comprising a second, different grade of graphite.

19. The printing assembly of claim 14, wherein the induction coil has an inner radius that is no greater than 1.4 times the effective radius of the nozzle body.

20. The printing assembly of claim 14, wherein the induction coil has an axial extent that is less than L.

21-31. (canceled)
